(19) United States
(12) Patent Application Publication
(10) Pub. No.: US 2019/0002093 A1
(43) Pub. Date: Jan. 3, 2019

(54) AIRCRAFT

(71) Applicant: Panasonic Intellectual Property Management Co., Ltd., Osaka (JP)

(72) Inventors: Fumio MURAMATSU, Kyoto (JP); Masayuki TOYAMA, Kanagawa (JP); Hiroyuki MATSUMOTO, Tokyo (JP); Shigenori ICHIMURA, Chiba (JP); Tatsuya IYOBE, Tochigi (JP); Mizuki TAKITA, Tokyo (JP)

(73) Assignee: Panasonic Intellectual Property Management Co., Ltd., Osaka (JP)

(21) Appl. No.: 15/748,934

(22) PCT Filed: Jul. 27, 2016
(86) PCT No.: PCT/JP2016/003462

§ 371 Date: Jan. 30, 2018

(30) Foreign Application Priority Data
Jul. 31, 2015 (JP) 2015-152301
Sep. 3, 2015 (JP) 2015-173373
Jun. 24, 2016 (JP) 2016-125963

(51) Int. Cl. B64C 27/00; B64B 1/02; B64B 1/60; B64C 27/22; B64C 15/02; B64C 39/02

(52) U.S. Cl. CPC B64C 27/006; B64B 1/02; B64B 1/60; B64C 27/22; B64C 15/02; B64C 39/024; B64D 47/08; B64C 2201/024; B64C 2201/101; B64C 2201/108; B64C 2201/042; B64C 2201/127; B64C 2201/022

(57) ABSTRACT

An aircraft includes: a plurality of rotor units each including propeller and motor that drives propeller; a shock absorber covering an entire vertical length of a lateral side of the plurality of rotor units; and a plurality of rudders each being disposed downstream of a corresponding one of the plurality of rotor units and rotating about axis of rotation that extends in a direction intersecting a flow direction of air current generated by the corresponding one of the plurality of rotor units.

### TECHNICAL FIELD

The present disclosure relates to an aircraft including a plurality of rotor units.

### BACKGROUND ART

Patent Literature (PLT) 1 discloses an aircraft including a plurality of rotor units each including a propeller. This type of aircraft is known as a multicopter or drone.

PLT 2 discloses an aircraft that includes: a single rotor unit including a propeller; and a buoyant body filled with helium gas. The buoyant body of the aircraft disclosed in PLT 2 is donut shaped, and the single rotor unit is disposed in the hole defined by the donut shape of the buoyant body.

### CITATION LIST

### Patent Literature

PLT 1: Japanese Unexamined Patent Application Publication No. 2011-046355
PLT 2: Japanese Unexamined Patent Application Publication No. 04-022386

### SUMMARY OF THE INVENTION

### Technical Problem

The rotor units of the aircraft disclosed in PLT 1 are exposed. The aircraft disclosed in PLT 2 achieves flight with a single rotor unit including a large propeller. The aircraft therefore includes, extending outward beyond the buoyant body, legs for supporting the weight of rotor unit when landing and fins for controlling flight direction. Thus, when these aircrafts contact an object mid-flight, parts necessary to achieve flight such as rotor units and fins may be damaged, which may result in loss of ability to maintain stable aircraft flight.

The present disclosure has been conceived in view of the above concerns, and has an object to maintain stable flight of an aircraft even when the aircraft contacts a person or object mid-flight.

### Solution to Problem

An aircraft according to the present disclosure includes: a plurality of rotor units each including a propeller and a motor that drives the propeller; a shock absorber covering an entire vertical length of a lateral side of the plurality of rotor units; and a plurality of rudders each being disposed downstream of a corresponding one of the plurality of rotor units and rotating about an axis of rotation that extends in a direction intersecting a flow direction of air current generated by the corresponding one of the plurality of rotor units.

### Advantageous Effect of Invention

The aircraft according to the present disclosure is capable of maintaining stable flight even when the aircraft contacts a person or object mid-flight.

### BRIEF DESCRIPTION OF DRAWINGS

FIG. 1 is a perspective view of the bottom of an aircraft according to Embodiment 1.

FIG. 2 is a plan view of the aircraft according to Embodiment 1.

FIG. 3 is a cross sectional view of the aircraft taken at line in FIG. 2.

FIG. 4 is a cross sectional view of the aircraft taken at line IV-IV in FIG. 2.

FIG. 5 is a top view showing a balloon according to Embodiment 1.

FIG. 6 is a cross-sectional view showing the balloon taken along a cross-section VI-VI in FIG. 5.

FIG. 7 is a perspective view illustrating an internal configuration of a ventilation hole of the aircraft according to Embodiment 1.

FIG. 8A is a schematic diagram showing an example cross section of a ventilation hole of the aircraft according to Embodiment 1 viewed from the central axis of the aircraft.

FIG. 8B is a schematic diagram showing another example cross section of a ventilation hole of the aircraft according to Embodiment 1 viewed from the central axis of the aircraft.

FIG. 9 is a block diagram showing a configuration of the aircraft according to Embodiment 1.

FIG. 10A is a diagram illustrating a state of the aircraft according to Embodiment 1 when the aircraft is under flight control for forward horizontal linear motion.

FIG. 10B is a diagram illustrating a state of the aircraft according to Embodiment 1 when the aircraft is under flight control for rightward horizontal linear motion.

FIG. 10C is a diagram illustrating a state of the aircraft according to Embodiment 1 when the aircraft is under flight control for diagonally forward right horizontal linear motion.

FIG. 11A is a diagram illustrating a state of the aircraft according to Embodiment 1 when the aircraft is under flight control for counterclockwise horizontal rotational motion.

FIG. 11B is a diagram illustrating a state of the aircraft according to Embodiment 1 when the aircraft is under flight control for clockwise horizontal rotational motion.

FIG. 12 is a diagram illustrating a state of an aircraft according to Variation 1 of Embodiment 1 when the aircraft is under flight control for forward horizontal linear motion.

FIG. 13 is a diagram illustrating a state of the aircraft according to Variation 1 of Embodiment 1 when the aircraft is under flight control for counterclockwise horizontal rotational motion.

FIG. 14 is a schematic diagram showing an example cross section of a ventilation hole of an aircraft according to Variation 2 of Embodiment 1 viewed from the central axis of the aircraft.

FIG. 15 is a cross sectional view of an aircraft according to Embodiment 2 and corresponds to FIG. 3.

FIG. 16 is a cross sectional view of an aircraft according to Embodiment 3 and corresponds to FIG. 3.

FIG. 17 is a cross sectional view of the balloon included in an aircraft according to Embodiment 4, and corresponds to FIG. 6.

FIG. 18 is a plan view of the balloon included in an aircraft according to Embodiment 5.

FIG. 19 is a plan view of an aircraft according to Embodiment 6.

FIG. 20 is a cross-sectional view showing the aircraft taken along a cross-section XX-XX in FIG. 19.

FIG. 21 is a plan view of an aircraft according to another embodiment.

FIG. 22 is a plan view of an aircraft according to another embodiment.

FIG. 23 illustrates a configuration of a balloon sheet.

### DESCRIPTION OF EXEMPLARY EMBODIMENTS

Hereinafter, non-limiting embodiments will be described in detail with reference to the accompanying drawings, but unnecessarily detailed descriptions may be omitted. For example, detailed descriptions of well-known matters or descriptions of components that are substantially the same as components described previous thereto may be omitted. This is to avoid redundancy and provide easily read descriptions for those skilled in the art.

Note that the inventors have provided the accompanying drawings and following detailed description in order for those skilled in the art to fully understand the present disclosure; the accompanying drawings and following detailed description are not intended to limit the scope of the accompanying claims.

### Embodiment 1

### Aircraft Schematic Framework

Hereinafter aircraft 10 according to Embodiment 1 will be described.

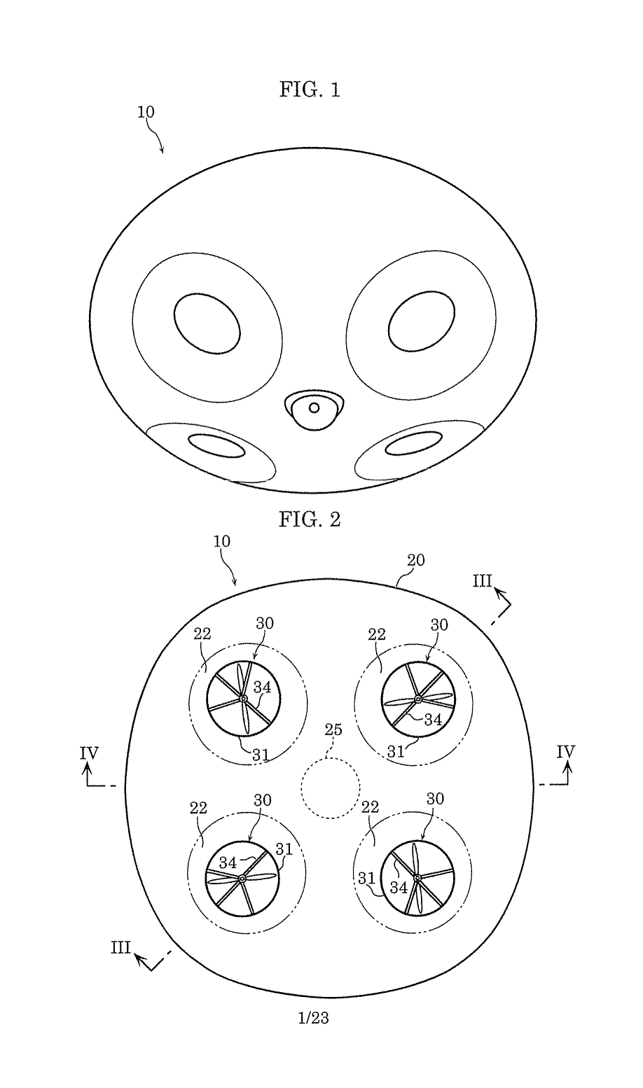

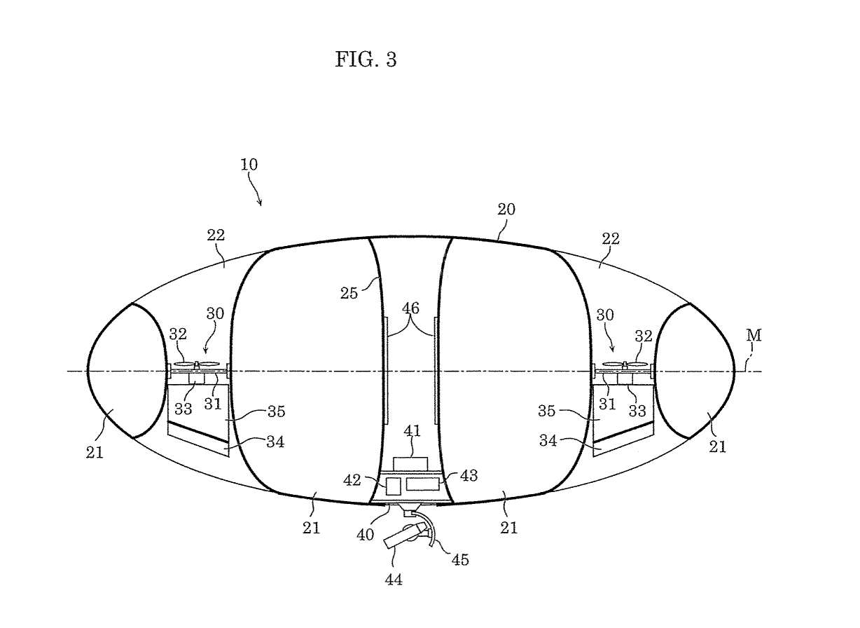

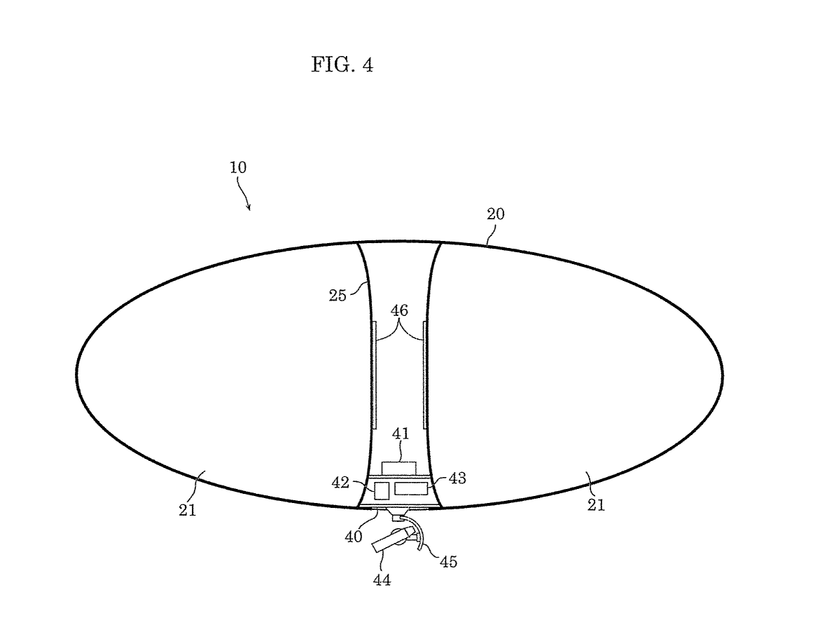

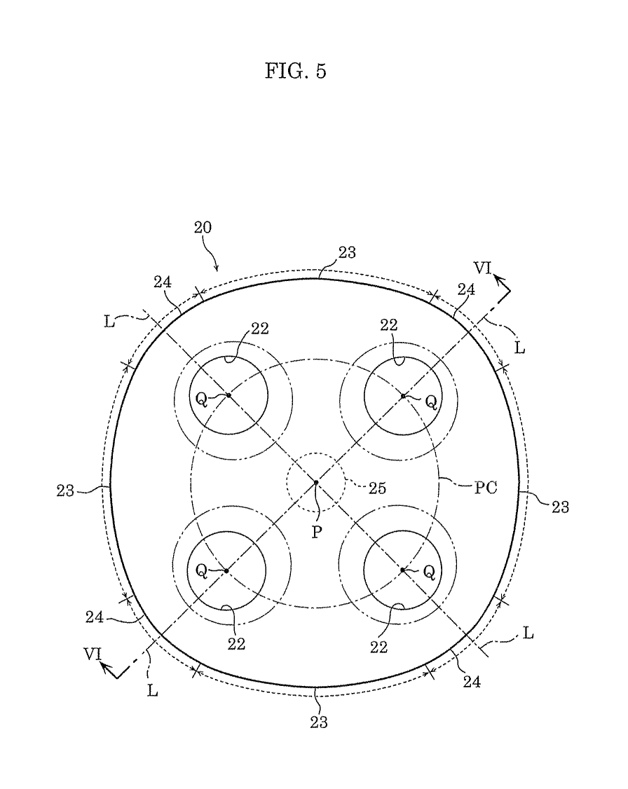

FIG. 1 is a perspective view of the bottom of the aircraft according to Embodiment 1. FIG. 2 is a plan view of the aircraft according to Embodiment 1. FIG. 3 is a cross sectional view of the aircraft taken at line III-III in FIG. 2. FIG. 4 is a cross sectional view of the aircraft taken at line IV-IV in FIG. 2.

As illustrated in FIG. 1 and FIG. 2, aircraft 10 according to Embodiment 1 includes a single balloon 20 as the shock absorber and four rotor units 30. Aircraft 10 also includes controller 41, battery 42, projector 43, and camera 44 as onboard devices, as illustrated in FIG. 3 and FIG. 4. Aircraft 10 further includes luminous body 46.

### Balloon

Next, balloon 20 will be described.

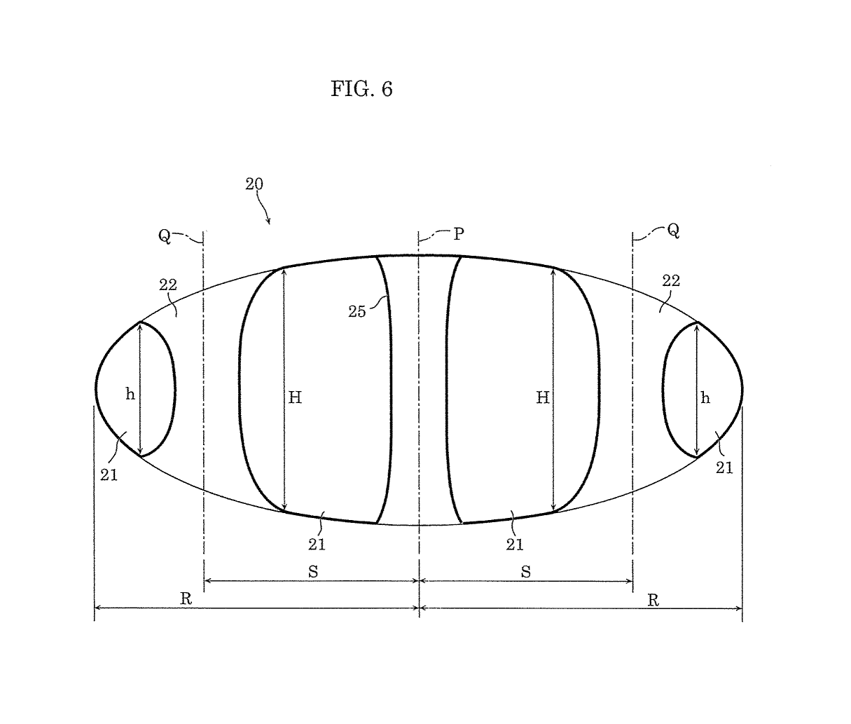

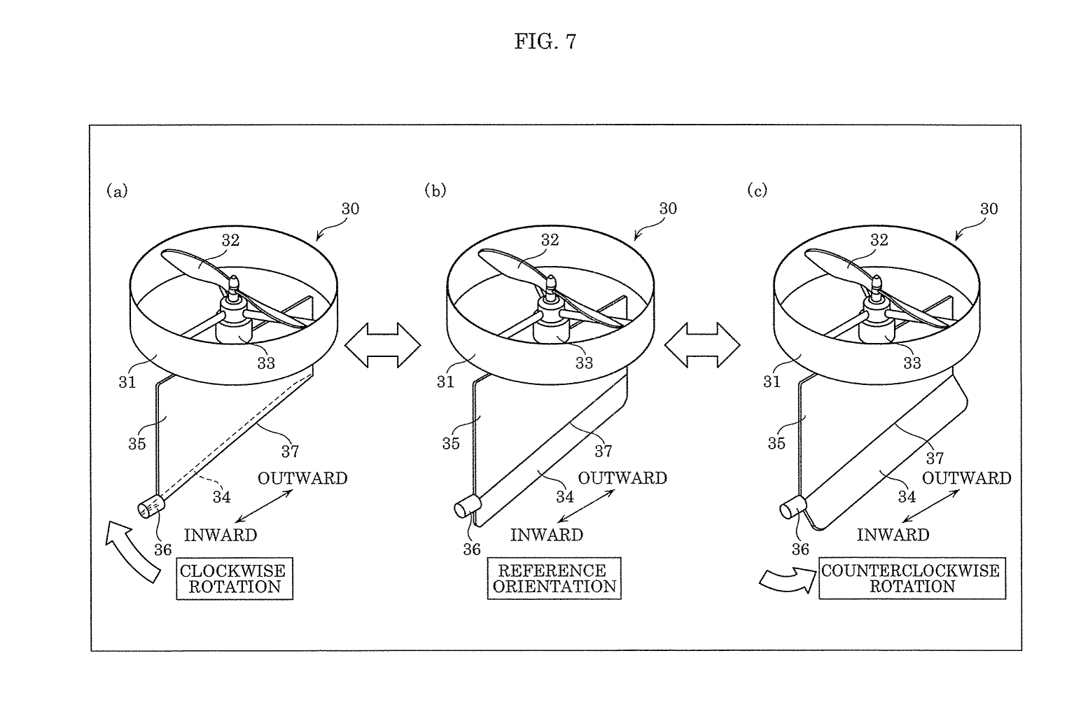

FIG. 5 is a top view showing the balloon according to Embodiment 1. FIG. 6 is a cross-sectional view showing the balloon taken along a cross-section VI-VI in FIG. 5.

As illustrated in FIG. 3, FIG. 4, and FIG. 6, balloon 20 is made of a flexible material (for example, vinyl chloride) formed in a sheet, and includes gas chamber 21, which is a space enclosed by the sheet. In FIG. 3, FIG. 4, and FIG. 6, the bold lines indicate the cross section of the sheet forming balloon 20. The material of the sheet forming the outer surface of balloon 20 is white in color and semitransparent so as to allow light to pass through. Gas chamber 21 formed by the sheet is filled with gas for providing buoyancy, such as helium. Gas filling gas chamber 21 may be gas that is less dense than the atmosphere.

As illustrated in FIG. 5, balloon 20 has rotational symmetry about a vertically extending line. This axis of symmetry is central axis P of balloon 20. Balloon 20 illustrated in FIG. 5 has a rotational symmetry of 90 degrees. In other words, balloon 20 has the same shape after each 90 degree rotation about central axis P.

As illustrated in FIG. 6, balloon 20 has a low profile. When viewed from the side, balloon 20 has a streamlined shape. Balloon 20 gradually decreases in height from its central region toward its peripheral edge. More specifically, in a cross section of balloon 20 taken along central axis P illustrated in FIG. 6, balloon 20 has an elliptical shape whose major axis extends horizontally and minor axis extends vertically. Stated differently, balloon 20 has a cross sectional shape that is essentially symmetrical about its horizontal axis. Note that the cross section of balloon 20 is not required to be an ellipse formally defined by focus points; balloon 20 may have a cross sectional shape that would generally be recognized as an ellipse at a glance.

Balloon 20 includes as many ventilation holes 22 as it does rotor units 30 (in this embodiment, balloon 20 includes four). As illustrated in FIG. 6, each ventilation hole 22 is a passageway having an approximately circular cross section and passes through balloon 20 in a vertical direction. Central axis Q of each ventilation hole 22 is approximately parallel to central axis P of balloon 20.

As illustrated in FIG. 6, central axis Q of each ventilation hole 22 is located closer to the peripheral edge of balloon 20 than a center point between central axis P and the peripheral edge of balloon 20. More specifically, distance S between central axis P of balloon 20 and central axis Q of ventilation hole 22 is longer than half of distance R between central axis P of balloon 20 and the peripheral edge of balloon 20 (S>R/2). Thus, rotor units 30 are located closer the peripheral edge of balloon 20 than central axis P of balloon 20. Arranging rotor units 30 in this manner makes it possible to secure enough space between rotor units 30 and stably fly aircraft 10.

The smallest cross sectional area of each ventilation hole 22 is located in the vertical central region of ventilation hole 22 (i.e., the area of a cross section taken perpendicular to central axis Q is smallest in the central region of ventilation hole 22). Each ventilation hole 22 has a shape that gradually expands in cross sectional area from the vertical central region toward the top end portion and from the vertical central region toward the bottom end portion. Stated differently, each ventilation hole 22 has the shape of a pillar with a pinched midsection. As described above, balloon 20 gradually decreases in height from its central region toward its peripheral edge. As such, with respect to each ventilation hole 22, the height h measured closer to the peripheral edge of balloon 20 is less than the height H measured closer to the central region of balloon 20.

As illustrated in FIG. 5, four ventilation holes 22 are arranged at 90 degree intervals around central axis P of balloon 20. Stated differently, four ventilation holes 22 are arranged to surround central axis P as a predetermined reference point of aircraft 10 in a top view. Central axes Q of ventilation holes 22 are equidistant from central axis P of balloon 20. Stated differently, central axis Q of each ventilation hole 22 is approximately orthogonal to one pitch circle PC centered about central axis P of balloon 20.

As illustrated in FIG. 5, in a top view, the peripheral edge of balloon 20 consists of reference curve sections 23 and small curvature radius sections 24. There are as many reference curve sections 23 as there are ventilation holes 22, and as many small curvature radius sections 24 as there are ventilation holes 22 (in this embodiment, four each). Reference curve sections 23 and small curvature radius sections 24 are alternately arranged around the peripheral edge of balloon 20 in a top view. Small curvature radius sections 24 are located at an outward side of ventilation holes 22 in one-to-one correspondence (i.e., located across ventilation holes 22 from central axis P of balloon 20). Each reference curve section 23 is disposed between two adjacent small curvature radius sections 24.

Reference curve sections 23 and small curvature radius sections 24 are both curved. The midpoint of the length (in the circumference direction) of each small curvature radius section 24 is located on line L that intersects central axis Q of the closest ventilation hole 22 as well as central axis P of balloon 20 at a right angle.

The radius of curvature of each small curvature radius section 24 is smaller than the radius of curvature of each reference curve section 23. However, the radius of curvature of each reference curve section 23 is not required to be constant across the entire length thereof. Moreover, the radius of curvature of each small curvature radius section 24 is not required to be constant across the entire length thereof. When the radiuses of curvatures of reference curve sections 23 and small curvature radius sections 24 are not constant, the maximum radius of curvature of small curvature radius section 24 is simply required to be less than the minimum radius of curvature of reference curve section 23.

As illustrated in FIG. 6, balloon 20 includes a tubular connector 25. Connector 25 is made of sheet-like light-transmissive material formed in the shape of a cylinder (or round tube) whose top and bottom end portions have a slightly increased diameter. Connector 25 is disposed such that its central axis is approximately coaxial with central axis P of balloon 20. In balloon 20, the top end of connector 25 is connected to the top portion of balloon 20 and the bottom end of connector 25 is connected to the bottom portion of balloon 20.

The top end of the tubular connector 25 is sealed, whereas the bottom end is open. The space inside connector 25 is therefore in communication with the space external to balloon 20. Air is present in the space inside connector 25, and the pressure inside the space is approximately equal to the atmospheric pressure.

As described above, balloon 20 has rotational symmetry about the vertically extending central axis P. The gas filling gas chamber 21 of balloon 20, such as helium, is evenly spread throughout gas chamber 21. As such, the working point of the buoyant force (i.e., the center of buoyancy) exerted by the gas filling balloon 20 is located approximately above central axis P of balloon 20.

The inner volumetric capacity of balloon 20 (i.e., the volumetric capacity of gas chamber 21) is determined such that the buoyant force of the gas filling balloon 20 is slightly less than the gross weight of aircraft 10. Thus, aircraft 10 slowly descends when rotor unit 30 stops mid-air.

### Rotor Unit

Next, rotor unit 30 will be described.

As illustrated in FIG. 2 and FIG. 3, each rotor unit 30 includes one each of frame 31, propeller 32, and motor 33.

Frame 31 includes a ring-shaped part and a spoke-shaped part extending from the center of frame 31 toward the ring-shaped part. Motor 33 is attached to the central region of frame 31. Propeller 32 is attached to the output shaft of motor 33. The axis of rotation of the output shaft of motor 33 (i.e., the axis of rotation of propeller 32) and the central axis of frame 31 are approximately coaxial. Note that propeller 32 includes a single propeller, but propeller 32 may include two propellers that rotate in opposite directions about the same axis of rotation (i.e., contra-rotating propellers).

A single rotor unit 30 is disposed in each ventilation hole 22. As such, rotor units 30 are disposed to surround central axis P of aircraft 10 in a top view. Each rotor unit 30 is disposed such that the axis of rotation of propeller 32 is approximately vertical. The axis of rotation of propeller 32 and the central axis Q of ventilation hole 22 are approximately coaxial. Rotor units 30 are disposed in the vertical central regions of ventilation holes 22. Stated differently, rotor units 30 are disposed to overlap center plane M passing through the vertical center of balloon 20, as illustrated in FIG. 3. Center plane M is a plane located in the vertical center of balloon 20 and intersects central axis P of balloon 20 at a right angle. The outer diameter of frame 31 of rotor unit 30 is approximately equal to the inner diameter of vertical central region of ventilation hole 22.

Rotor units 30 are disposed in ventilation holes 22 such that the entire height of rotor unit 30 fits in ventilation hole 22. Stated differently, the lateral sides of each rotor unit 30 are covered by balloon 20 across the entire vertical length of rotor unit 30. Note that “vertical” refers to when aircraft 10 is level, not tilted. Stated differently, “vertical” is substantially parallel to the axis of rotation of rotor unit 30.

Moreover, ventilation hole 22 more preferably has such a height that the distance from the vertical center of rotor unit 30 to the top of ventilation hole 22 and the distance from the vertical center of rotor unit 30 to the bottom of ventilation hole 22 are each greater than or equal to the diameter of rotor unit 30. With this, even if the axis of rotation of propeller 32 of rotor unit 30 were to rotate 90 degrees relative to aircraft 10 as a result of, for example, rotor unit 30 experiencing an impact or rotor unit 30 malfunctioning, protrusion of rotor unit 30 out of ventilation hole 22 can be reduced. Thus, balloon 20 can cover the lateral sides of rotor unit 30 to a degree whereby rotor unit 30 cannot easily contact an object.

### Rudders and Flow Conditioning Plates

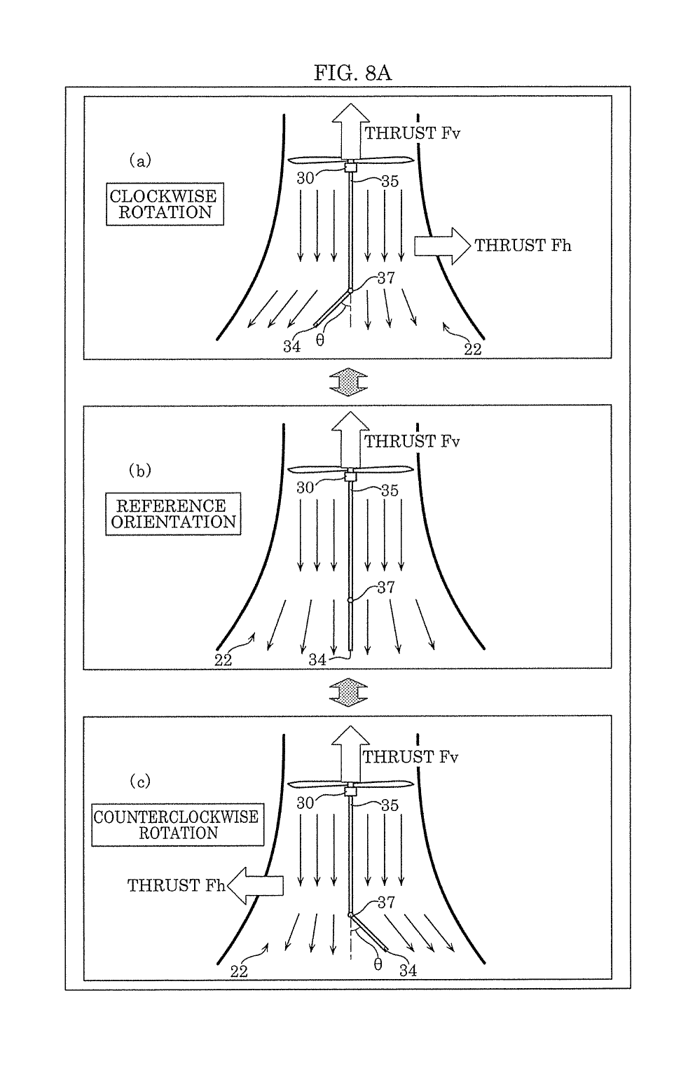

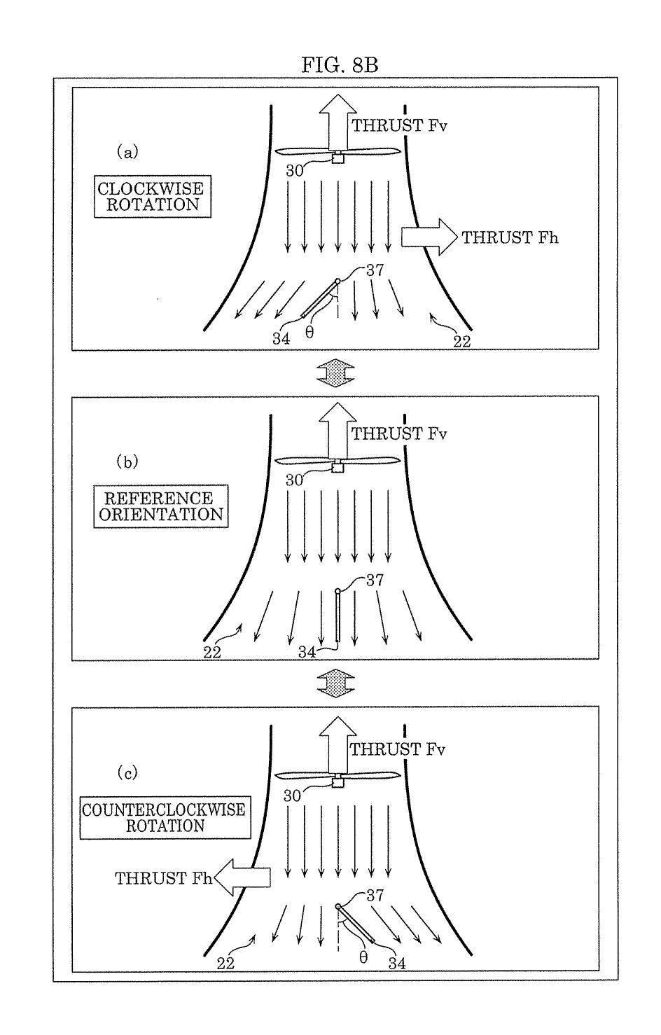

Referring to FIG. 2, FIG. 3, FIG. 7, and FIG. 8, rudders 34 and flow conditioning plates 35 will be described.

FIG. 7 is a perspective view illustrating an internal configuration of a ventilation hole of the aircraft according to Embodiment 1. In FIG. 7, the left front on the drawing indicates the inward side of aircraft 10 (central axis P side), whereas the right back on the drawing indicates the outward side located in a more peripheral position relative to aircraft 10.

As illustrated in FIG. 2, FIG. 3, and FIG. 7, aircraft 10 includes, inside each ventilation hole 22, movable rudder 34 and air conditioning plate 35 in addition to rotor unit 30. Stated differently, a plurality of movable rudders 34 and a plurality of air conditioning plates 35 are provided for the respective rotor units 30 (in the present embodiment, there are four rotor units 30). Each of rudders 34 has the same configuration and each of air conditioning plates 35 has the same configuration, and thus rudder 34 and air conditioning plate 35 included in one ventilation hole 22 will be described below.

Rudder 34 is disposed at the bottom end portion of ventilation hole 22, and at the downstream of a single rotor unit 30. Each rudder 34 is an elongated plate-shaped component, and in a top view of aircraft 10, when in an unrotated reference orientation, is disposed approximately parallel to line PQ connecting central axis P of aircraft 10 and central axis Q of ventilation hole 22 in which rudder 34 is disposed.

Rudder 34 is disposed in an orientation in which its outer short side located in a more peripheral position relative to aircraft 10 is positioned higher than its inner short side located in a more inward position relative to aircraft 10. Moreover, rudder 34 can move about the upstream portion (its upper long side) located upstream (rotor unit 30 side) as an axis of rotation 37, as illustrated in FIG. 7. In other words, axis of rotation 37 of rudder 34 is disposed to tilt horizontally such that its outer end located in a more peripheral position relative to aircraft 10 is positioned higher than its inner end located in a more inward position relative to aircraft 10. Rudder 34 rotates about axis of rotation 37 that extends in the direction intersecting the flow direction of air current generated by the corresponding rotor unit 30. Stated differently, rudder 34 is disposed in an orientation in which axis of rotation 37 of such rudder 34 is along line PQ that connects central axis P of aircraft 10 and central axis Q of ventilation hole 22 in which such rudder 34 is included. Rudder 34 changes the flow direction of air current generated by rotor unit 30 by titling as a result of rotating about axis of rotation 37. Here, approximately parallel to line PQ in a top view means within a range of −30 degrees to +30 degrees, inclusive, with respect to line PQ. Stated differently, the direction in which axis of rotation 37 of rudder 34 extends and the direction in which an axis of rotation of rotor unit 30 extends intersect within a range of 60 degrees to 120 degrees.

Rudder 34 includes actuator 36 serving as the power for rudder 34 to rotate about axis of rotation 37. An example of actuator 36 is a servo motor. Actuator 36 tilts rudder 34 by rotating either clockwise or counterclockwise by predetermined degrees (for example, 45 degrees) with respect to the reference orientation shown in (b) in FIG. 7. By being rotated by actuator 36, rudder 34 transits, for example, from the reference orientation to a state after rotating counterclockwise shown in (c) in FIG. 7 or to a state after rotating clockwise.

A plurality of actuators 36 rotate independently, and thus a plurality of rudders 34 rotate independently. Stated differently, one and another of rudders 34 may rotate in different rotational directions, or may rotate in the same rotational direction, or one of rudders 34 may remain in the reference orientation while another rudder 34 may rotate in either rotational direction.

Note that each of actuators 36 is disposed in rudder 34 at a position facing the inward side of aircraft 10. As will be described later, controller 41 that controls aircraft 10 and battery 42 that supplies power are disposed at the horizontal center of aircraft 10. Accordingly, it becomes possible to shorten the lengths of lines, such as signal lines and power lines, running from controller 41 and battery 42 to actuators 36.

Flow conditioning plate 35 is an elongated plate-shaped component disposed between rudder 34 and rotor unit 30 disposed in the vertical central region of ventilation hole 22. In the top view of aircraft 10 illustrated in FIG. 2, each flow conditioning plate 35 is arranged approximately parallel to line PQ, and divides the area of ventilation hole 22 in a horizontal plane into two approximately equal parts. Stated differently, in a top view, flow conditioning plate 35 is arranged in a position that passes through central axis Q of ventilation hole 22.

Orientations as well as linear motion and rotational motion of aircraft 10 along horizontal directions can be controlled by adjusting the respective angles of rudders 34 included in the respective four ventilation holes 22. Rudders 34 may be provided in all four ventilation holes 22, as illustrated in FIG. 2, and, alternatively, may be provided in two ventilation holes 22 aligned in the direction in which balance of the orientation of aircraft 10 is desired to be achieved.

Note that aircraft 10 is not required to include any flow conditioning plates 35.

Referring to FIG. 8A and FIG. 8B, thrusts acting on aircraft 10 when an angle of rudder 34 is adjusted will be described.

FIG. 8A is a schematic diagram showing an example cross section of a ventilation hole of the aircraft according to Embodiment 1 viewed from the central axis of the aircraft. FIG. 8B is a schematic diagram showing another example cross section of a ventilation hole of the aircraft according to Embodiment 1 viewed from the central axis of the aircraft. Note that FIG. 8B illustrates a ventilation hole of the aircraft including no air conditioning plate 35.

As illustrated in (b) in FIG. 8A and in FIG. 8B, when rudder 34 is in the reference orientation, air current generated by rotor unit 30 flows inside ventilation hole 22 from the top to the bottom. For this reason, vertical thrust Fv will act on aircraft 10, while no horizontal thrust will act on aircraft 10.

As illustrated in (a) in FIG. 8A and in FIG. 8B, when rudder 34 is rotated clockwise to tilt leftward on the drawing by a predetermined angle θ with respect to axis of rotation 37, air current generated by rotor unit 30 flows along a direction toward which rudder 34 has been tilted. More specifically, the flow direction of the air current has been changed by rudder 34, as a result of which the air current flows diagonally to the left toward which rudder 34 is tilted. Accordingly, not only vertical thrust Fv but also rightward horizontal thrust Fh, which is opposite to the left toward which rudder 34 is tilted, will act on aircraft 10.

Similarly, as illustrated in (c) FIG. 8A and in FIG. 8B, when rudder 34 is rotated counterclockwise to tilt rightward on the drawing by a predetermined angle θ with respect to axis of rotation 37, air current generated by rotor unit 30 flows along a direction toward which rudder 34 has been tilted. More specifically, the flow direction of the air current has been changed by rudder 34, as a result of which the air current flows diagonally to the right toward which rudder 34 is tilted. Accordingly, not only vertical thrust Fv but also leftward horizontal thrust Fh, which is opposite to the right toward which rudder 34 is tilted, will act on aircraft 10.

Note that in the above description, a fixed value of 45 degrees is used as an example of the predetermined angle θ by which rudder 34 is tilted, but such angle may be adjusted according to a desired magnitude of thrust acting in a horizontal direction.

Note that when rudder 34 is tilted either to the left or to the right, a thrust acting in a vertical direction decreases than in the case where rudder 34 is in the reference orientation. To cope with this, a thrust acting in a vertical direction when rudder 34 is in the reference orientation may be maintained even when rudder 34 is tilted either to the left or to the right, by increasing the rotational speed of rotor unit 30 for the case where rudder 34 is tilted either to the left or to the right to a speed faster than the rotational speed of rotor unit 30 for the case where rudder 34 is in the reference orientation.

### Onboard Devices, Luminous Body, Etc

As described above, aircraft 10 includes onboard devices, including controller 41, battery 42, projector 43, and camera 44. Aircraft 10 also includes luminous body 46.

As illustrated in FIG. 3, aircraft 10 includes disk 40. Disk 40 is a disk-shaped component approximately equal in diameter to the bottom end of connector 25, and is disposed so as to cover the bottom end of connector 25. Disk 40 may be made from a resin material such as polypropylene (PP), polycarbonate (PC), polybutylene terephthalate (PBT), and acrylonitrile butadiene styrene (ABS) resin, or from metal such as aluminum, copper, and stainless steel.

Camera 44, which is used for photography purposes, is attached to the bottom surface of disk 40 via gimbal 45. Camera 44 is designed to photograph images from above, and as such, is disposed facing downward at an angle. Gimbal 45 is a component for maintaining the orientation of camera 44 even when the orientation of aircraft 10 changes.

Controller 41, battery 42, and projector 43 are disposed above disk 40. Controller 41 receives command signals transmitted from a radio remote control, and controls rotor unit 30, camera 44, projector 43, and LEDs in accordance with the received command signals. Controller 41 also transmits images taken by camera 44, for example. Battery 42 supplies power to rotor units 30, controller 41, projector 43, and luminous body 46. Projector 43 projects images on an inner surface of balloon 20 made of semi-transparent material.

Luminous body 46 is an LED light strip including an elongated flexible printed substrate and multiple light-emitting elements (such as LEDs) aligned in the lengthwise direction of the elongated flexible printed substrate. In the vertical central region of connector 25, luminous body 46 is wound into a tubular helical coil such that the LEDs face outward. In other words, luminous body 46 covers the inside surface of connector 25. As such, luminous body 46 is subjected to the pressure inside gas chamber 21 acting on connector 25, and the space inside connector 25 is maintained at a predetermined tubular shape. Stated differently, luminous body 46 restricts inward movement of connector 25 from inside connector 25 so that connector 25 does not become narrower than a predetermined tubular shape. As described above, connector 25 is made of a light transmissive material. As such, light emitted from luminous body 46 passes through connector 25 and strikes the inner surface of balloon 20, which is made of semi-transparent material.

Note that luminous body 46 is exemplified as an LED light strip wound into a tubular helical coil, but luminous body 46 is not limited to this example. For example, luminous body 46 includes a tubular component and light-emitting elements which are separate components from the tubular component. Stated differently, a tubular luminous body can be achieved by combining a tubular component and substrates on which LEDs are mounted.

### Aircraft Flying Orientation

As described above, with aircraft 10, onboard devices such as controller 41 and battery 42 are disposed at the bottom end portion of the space inside connector 25. Stated differently, the relatively heavy onboard devices are concentrated in the bottom part of aircraft 10. As a result, the overall center of gravity of aircraft 10 is positioned lower than the working point of the buoyant force exerted by the gas filling balloon 20. Consequently, even when rotor unit 30 stalls, aircraft 10 does not rotate about its roll or pitch axes and can thus maintain the downward orientation of camera 44.

Moreover, the relatively heavy onboard devices are installed below rotor unit 30. As a result, the overall center of gravity of aircraft 10 is positioned lower than the working point of the buoyant force resulting from rotor unit 30 running. Consequently, even when rotor unit 30 is running, aircraft 10 can maintain the downward orientation of camera 44.

Aircraft 10 includes a plurality of rotor units 30. As such, when aircraft 10 is desired to travel in a substantially horizontal direction, a horizontal propulsion may be increased by increasing the rotational speed of rotor unit 30 located backward relative to the direction of travel to a speed faster than the rotational speed of rotor unit 30 located forward relative to the direction of travel.

Note that “the rotational speed of rotor unit 30” means the rotational speed of propeller 32 (the number of rotations of propeller 32 per unit time) included in rotor unit 30.

### Examples of Aircraft Motion Control

In the present embodiment, the flight of aircraft 10 is controlled by rotating rudders 34 to achieve linear motion and rotational motion of aircraft 10 along horizontal directions.

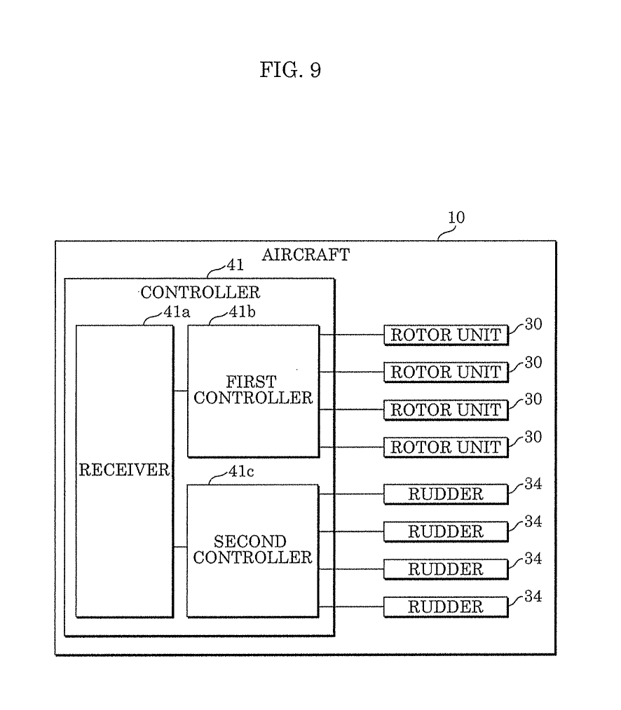

Referring to FIG. 9 to FIG. 11B, flight controls of aircraft 10 will be described below.

FIG. 9 is a block diagram showing a configuration of the aircraft according to Embodiment 1. Note that FIG. 9 omits the illustration of other components such as battery 42 and camera 44.

Controller 41 receives command signals from the radio remote control, and controls a plurality of rotor units 30 and a plurality of actuators 36a to 36d in accordance with the received command signals. Controller 41 includes receiver 41a, first controller 41b, and second controller 41c.

Receiver 41a receives the command signals transmitted from the radio remote control operated by the operator. Receiver 41a receives signals including, for example, a command signal indicating linear motion in horizontal directions, a command signal indicating horizontal rotational motion, and a command signal indicating ascent or descent of the aircraft. Receiver 41a may receive signals other than these command signals.

First controller 41b controls the number of rotations of a plurality of rotor units 30 in accordance with command signals received by receiver 41a. By controlling the number of rotations of a plurality of rotor units 30, first controller 41b controls ascent or descent of aircraft 10, the tilting of aircraft 10 with respect to a horizontal direction, and the flight of the aircraft in horizontal directions.

Second controller 41c controls the tilting of a plurality of rudders 34 in accordance with the command signals received by receiver 41a. In the present embodiment, second controller 41c controls the tilting of rudders 34 in accordance with, for example, a command signal indicating linear motion in horizontal directions and a command signal indicating horizontal rotational motion. Second controller 41c may control the tilting of a plurality of rudders 34 independently from first controller 41b. Stated differently, second controller 41c may control the tilting of a plurality of rudders 34 independently of the number of rotations of rotor units 30.

Note that first controller 41b and second controller 41c may be implemented as processors in different hardware. Alternatively, the functions of first controller 41b and second controller 41c may be implemented as software in a processor of the same hardware.

The following more specifically describes a state of aircraft 10 when controller 41 controls the flight of aircraft 10 for horizontal linear motion.

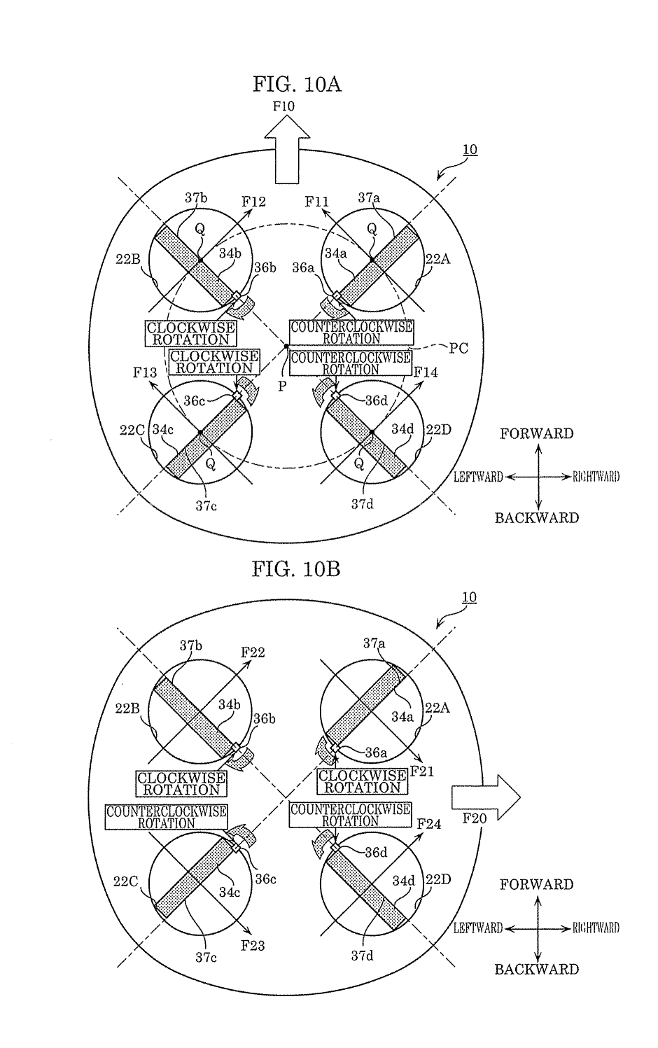

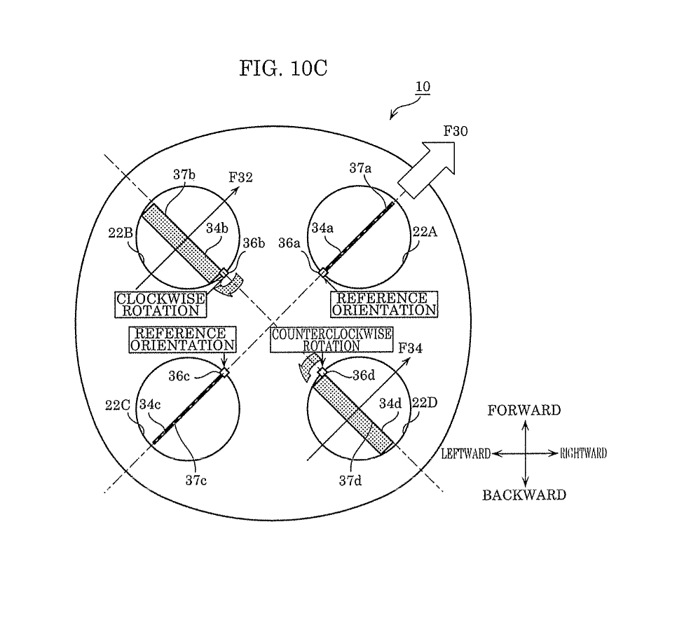

FIG. 10A is a diagram illustrating a state of the aircraft according to Embodiment 1 when the aircraft is under flight control for forward horizontal linear motion. FIG. 10B is a diagram illustrating a state of the aircraft according to Embodiment 1 when the aircraft is under flight control for rightward horizontal linear motion. FIG. 10C is a diagram illustrating a state of the aircraft according to Embodiment 1 when the aircraft is under flight control for diagonally forward right horizontal linear motion. FIG. 11A is a diagram illustrating a state of the aircraft according to Embodiment 1 when the aircraft is under flight control for counterclockwise horizontal rotational motion. FIG. 11B is a diagram illustrating a state of the aircraft according to Embodiment 1 when the aircraft is under flight control for clockwise horizontal rotational motion.

Note that FIG. 10A to FIG. 11B omit the illustration of rotor units 30 in aircraft 10. Also note that rudder 34a and actuator 36a are disposed in ventilation hole 22 located at the right front side of aircraft 10. Rudder 34b and actuator 36b are disposed in ventilation hole 22 located at the left front side of aircraft 10. Rudder 34c and actuator 36c are disposed in ventilation hole 22 located at the left back side of aircraft 10. Rudder 34d and actuator 36d are disposed in ventilation hole 22 located at the right back side of aircraft 10.

### (Linear Motion)

First, flight control will be described for the case where aircraft 10 moves linearly in the forward horizontal direction.

As described above, in linear motion, a horizontal propulsion is controlled to increase (by first controller 41b) by increasing the rotational speed of rotor unit 30 located backward relative to the direction of travel to a speed faster than the rotational speed of rotor unit 30 located forward relative to the direction of travel. Further in linear motion, the orientations of a plurality of rudders 34 are controlled (by second controller 41c).

Hereinafter, control of the orientations of a plurality of rudders 34 by second controller 41c will be described. The following description assumes that first controller 41b is controlling the rotational speed of rotor units 30 so as to increase a horizontal propulsion.

When receiver 41a receives a command signal indicating forward horizontal linear motion, second controller 41c causes rudders 34a and 34d located at the right side of aircraft 10, as illustrated in FIG. 10A, to rotate counterclockwise, by causing actuators 36a and 36d of rudders 34a and 34d to rotate counterclockwise. In this case, second controller 41c causes rudders 34b and 34c located at the left side of aircraft 10 to rotate clockwise, by causing actuators 36b and 36c of rudders 34b and 34c to rotate clockwise.

Accordingly, rudders 34a to 34d are tilted to an orientation in which their downstream portions (bottom long sides) located downstream of rotor units 30 face backward relative to the direction of travel of aircraft 10. More specifically, of rudders 34a to 34d, rudders 34a and 34c, which are aligned across central axis P of aircraft 10, are tilted to an orientation in which their downstream portions are positioned diagonally backward right with respect to axes of rotation 37a and 37c, which are their upstream portions. As such, thrusts F11 and F13 in a diagonally forward left direction, which is opposite to the side toward which rudders 34a and 34c are tilted, will act on ventilation holes 22A and 22C, respectively.

Moreover, of rudders 34a to 34d, rudders 34b and 34d, which are aligned across central axis P of aircraft 10, are tilted to an orientation in which their downstream portions are positioned diagonally backward left with respect to axes of rotation 37b and 37d, which are their upstream portions. As such, thrusts F12 and F14 in a diagonally forward right direction, which is opposite to the side toward which rudders 34b and 34d are tilted, will act on ventilation holes 22B and 22D, respectively.

Thrusts F11 to F14 each have forward components, and thus forward resultant force F10 will act on aircraft 10. Note that thrusts F11 and F13 have leftward components, whereas thrusts F12 and F14 have rightward components. Stated differently, the direction of components of thrusts F11 and F13 and the direction of components of thrusts F12 and F14 are different in the left-right direction. As such, thrusts acting on aircraft 10 in the left-right direction cancel out each other, resulting in forward resultant force F10.

Note that a description of the case where aircraft 10 moves linearly in the backward horizontal direction will be omitted, for the rotational directions of actuators 36a to 36d of rudders 34a to 34d when aircraft 10 moves linearly in the forward horizontal direction are simply required to be reversed.

Next, flight control will be described for the case where aircraft 10 moves linearly in the rightward horizontal direction.

When receiver 41a receives a command signal indicating rightward horizontal linear motion, second controller 41c causes rudders 34a and 34b located at the front side of aircraft 10, as illustrated in FIG. 10B, to rotate clockwise, by causing actuators 36a and 36b of rudders 34a and 34b to rotate clockwise. In this case, second controller 41c causes rudders 34c and 34d located at the back side of aircraft 10 to rotate counterclockwise, by causing actuators 36c and 36d of rudders 34c and 34d to rotate counterclockwise.

Accordingly, rudders 34a to 34d are tilted to an orientation in which their downstream portions face backward relative to the direction of travel of aircraft 10. More specifically, of rudders 34a to 34d, rudders 34a and 34c, which are aligned across central axis P of aircraft 10, are tilted to an orientation in which their downstream portions are positioned diagonally forward left with respect to axes of rotation 37a and 37c, which are their upstream portions. As such, thrusts F21 and F23 in a diagonally backward right direction, which is opposite to the side toward which rudders 34a and 34c are tilted, will act on ventilation holes 22A and 22C, respectively.

Moreover, of rudders 34a to 34d, rudders 34b and 34d, which are aligned across central axis P of aircraft 10, are tilted to an orientation in which their downstream portions are positioned diagonally backward left with respect to axes of rotation 37b and 37d, which are their upstream portions. As such, thrusts F22 and F24 in a diagonally forward right direction, which is opposite to the side toward which rudders 34b and 34d are tilted, will act on ventilation holes 22B and 22D, respectively.

Thrusts F21 to F24 each have rightward components, and thus rightward resultant force F20 will act on aircraft 10. Note that thrusts F21 and F23 have backward components, whereas thrusts F22 and F24 have forward components. Stated differently, the direction of components of thrusts F21 and F23 and the direction of components of thrusts F22 and F24 are different in the back-and-forth direction. As such, thrusts acting on aircraft 10 in the back-and-forth direction cancel out each other, resulting in rightward resultant force F20.

Note that a description of the case where aircraft 10 moves linearly in the leftward horizontal direction will be omitted, for the rotational directions of actuators 36a to 36d of rudders 34a to 34d when aircraft 10 moves linearly in the rightward horizontal direction are simply required to be reversed.

Hereinafter, flight control will be described for the case where aircraft 10 moves linearly in a diagonally forward right horizontal direction.

When receiver 41a receives a command signal indicating linear motion in a diagonally forward right horizontal direction, second controller 41c causes rudders 34a and 34c, which are aligned along the direction of travel of aircraft 10 as illustrated in FIG. 10C, to remain in the reference orientation, without causing actuators 36a and 36c of rudders 34a and 34c to rotate. In this case, second controller 41c causes rudder 34b to rotate clockwise, out of rudders 34b and 34d aligned along the vertical direction relative to the direction of travel of aircraft 10, by causing actuator 36b of rudder 34b to rotate clockwise. Furthermore, second controller 41c causes rudder 34d to rotate counterclockwise, out of rudders 34b and 34d, by causing actuator 36d of rudder 34d to rotate counterclockwise.

Accordingly, rudders 34b and 34d are tilted to an orientation in which their downstream portions face backward relative to the direction of travel of aircraft 10. More specifically, of rudders 34a to 34d, rudders 34a and 34d, which are aligned across central axis P of aircraft 10, are tilted to an orientation in which their downstream portions are positioned diagonally backward left with respect to axes of rotation 37b and 37d, which are their upstream portions. As such, diagonally forward right thrusts F32 and F34, which are opposite to the side toward which rudders 34b and 34d are tilted, will act on ventilation holes 22B and 22D, respectively.

Since rudders 34a and 34c remain in the reference orientation, no vertical thrust will act on rudders 34a and 34c. Stated differently, since only diagonally forward right thrusts F32 and F34 will act on aircraft 10 in the horizontal direction, diagonally forward right resultant force F30 will act on aircraft 10.

Note that a description of the case where aircraft 10 moves linearly in a diagonally backward left horizontal direction will be omitted, for the rotational directions of actuators 36a to 36d of rudders 34a to 34d when aircraft 10 moves linearly in a diagonally forward right horizontal right direction are simply required to be reversed. Also note that a description of the case where aircraft 10 moves linearly in a diagonally forward left horizontal direction will be omitted, for rudders aligned along the left-right direction are simply required to rotate in the reverse direction relative to the case where the aircraft moves linearly in a diagonally forward right horizontal direction. Similarly, when aircraft 10 moves linearly in a diagonally backward right horizontal direction, rudders which are aligned in the back-and-forth direction are simply required to rotate in the reverse direction relative to the case where the aircraft moves linearly in a diagonally forward right horizontal direction.

As described above, when aircraft 10 moves linearly in horizontal directions, each of a plurality of rudders 34a to 34d tilts in an orientation in which its upstream portion at the upstream of such rudder is located more forward in the direction of travel of aircraft 10 than its downstream portion located downstream of the air current generated by rotor unit 30 corresponding to each of rudders 34a to 34d. Note that in the present embodiment, the upstream portions at the upstream are at the same positions of axes of rotations 37, but the positions of the upstream portions and axes of rotations 37 are not required to be the same. For example, axes of rotation may be disposed between the upstream portions located upstream of the respective rudders and the downstream portions located downstream of the respective rudders, or may be disposed at the positions of the downstream portions.

### (Rotational Motion)

Hereinafter, flight control will be described for the case where aircraft 10 rotates along horizontal directions. The following describes flight control for rotational motion when aircraft 10 rotates about central axis P of aircraft 10 as an axis of rotation.

First, flight control will be described for the case where aircraft 10 rotates horizontally counterclockwise.

When receiver 41a receives a command signal indicating horizontally counterclockwise rotation, second controller 41c causes rudders 34a to 34d to rotate counterclockwise, by causing actuators 36a to 36d of rudders 34a to 34d of aircraft 10 to rotate counterclockwise, as illustrated in FIG. 11A.

Accordingly, rudders 34a to 34d are tilted to an orientation in which their downstream portions face backward relative to the direction of rotation. More specifically, rudder 34a is tilted to an orientation in which its downstream portion is positioned diagonally backward right with respect to axis of rotation 37a, which is its upstream portion. As such, thrust F41 in a diagonally forward left direction, which is opposite to the side toward which rudder 34a is tilted, will act on ventilation hole 22A.

Also, rudder 34b is tilted to an orientation in which its downstream portion is positioned diagonally forward right with respect to axis of rotation 37b, which is its upstream portion. As such, thrust F42 in a diagonally backward left direction, which is opposite to the side toward which rudder 34b is tilted, will act on ventilation hole 22B.

Also, rudder 34c is tilted to an orientation in which its downstream portion is positioned diagonally forward left with respect to axis of rotation 37c, which is its upstream portion. As such, thrust F43 in a diagonally backward right direction, which is opposite to the side toward which rudder 34c is tilted, will act on ventilation hole 22C.

Also, rudder 34d is tilted to an orientation in which its downstream portion is positioned diagonally backward left with respect to axis of rotation 37d, which is its upstream portion. As such, thrust F44 in a diagonally forward right direction, which is opposite to the side toward which rudder 34d is tilted, will act on ventilation hole 22D.

While thrusts F41 to F44 act on aircraft 10, thrust F41 is in a diagonally forward left direction, thrust F42 is in a diagonally backward left direction, thrust F43 is in a diagonally backward right direction, and thrust F44 is in a diagonally forward right direction, which means that a total sum of thrusts F41 to F44 is zero. Stated differently, no force for linear motion will act on aircraft 10.

Meanwhile, each of thrusts F41 to F44 is along the direction of counterclockwise rotation about central axis P of aircraft 10 serving as an axis of rotation, and thus rotational moment M40 for counterclockwise rotation about central axis P will act on aircraft 10.

Note that when aircraft 10 rotates horizontally clockwise, thrusts F51 to F54, which are in the opposite directions of thrusts F41 to F44 as illustrated in FIG. 11B, will act on aircraft 10, by reversing the rotational directions of actuators 36a to 36d of rudders 34a to 34d for the case where aircraft 10 rotates horizontally counterclockwise. Accordingly, rotational moment M50 for clockwise rotation, which is in the opposite direction of rotational moment M40, will act on aircraft 10, thereby enabling aircraft 10 to rotate clockwise.

As described above, when aircraft 10 rotates, each of rudders 34a to 34b tilts so that its upstream portion at the upstream is positioned more forward in the direction of rotation of aircraft 10 than its downstream portion at the downstream of the air current generated by the corresponding rotor unit 30. As such, each of rudders 34a to 34d tilts toward the identical direction to one another, when viewed from central axis P of aircraft 10 as a predetermined reference point.

### Advantageous Effects of Embodiment 1

Aircraft 10 according to the present embodiment includes: a plurality of rotor units 30 each including propeller 32 and motor 33 that drives propeller 32; balloon 20 as a shock absorber covering an entire vertical length of a lateral side of the plurality of rotor units 30; and a plurality of rudders 34 each being disposed downstream of a corresponding one of the plurality of rotor units 30 and rotating about an axis of rotation that extends in a direction intersecting a flow direction of air current generated by the corresponding one of the plurality of rotor units 30.

With aircraft 10, since the lateral sides of the plurality of rotor units 30 are covered by balloon 20 across the entire vertical length of rotor units 30, if aircraft 10 contacts an object mid-flight, balloon 20 will contact the object instead of rotor units 30. Stated differently, even if aircraft 10 contacts an object mid-flight, contact between rotor units 30 and the object can be avoided. Thus, according to Embodiment 1, even if aircraft 10 contacts an object mid-flight, damage to rotor units 30 resulting from the contact can be prevented and stable flight of aircraft 10 can be maintained.

Moreover, if aircraft 10 were to crash into the ground, the gas-filled balloon 20 would contact the ground and deform, thereby softening the impact. As such, Embodiment 1 can prevent damage to rotor unit 30 resulting from a crash. Moreover, even if aircraft 10 were to crash into the ground, since the gas-filled balloon 20 would contact the object rather than rotor unit 30 or onboard device, damage to the object from contact with aircraft 10 can be reduced.

As in the case of aircraft 10 according to the present embodiment in which the lateral sides of the plurality of rotor units 30 are covered by balloon 20, the mere control of the number of rotations of rotor units 30 is insufficient to effectively move aircraft 10 in horizontal directions. Because of the structure of rotor units 30 whose lateral sides covered by balloon 20, the rotations of propellers 32 of rotor units 30 are less likely to act on the air around aircraft 10.

To cope with this problem, in aircraft 10 according to the present embodiment, the plurality of rudders 34a to 34d are disposed downstream of the corresponding rotor units 30 and each rotate independently about axis of rotation 37 that extends in a direction intersecting a flow direction of air current generated by the corresponding rotor unit. As such, by tilting the orientations of the plurality of rudders 34a to 34d with respect to air currents generated by a plurality of rotor units 30, it becomes possible to tilt the flow directions of the air currents. Accordingly, even with the structure in which the lateral sides of the plurality of rotor units 30 are covered by balloon 20, not only a vertical thrust but also a horizontal thrust can be acted upon the air around aircraft 10. This makes it easy to effectively move aircraft 10 in horizontal directions.

For example, when aircraft 10 moves linearly in horizontal directions, the tilting of rudders 34 are controlled after the orientation of aircraft 10 has been tilted. This enables the air currents generated by rotor units 30 to be tilted to an angle closer to the horizontal direction, and thus to increase a horizontal thrust acting on aircraft 10. Accordingly, it becomes possible to effectively move aircraft 10 linearly in horizontal directions, thereby reducing the power consumption.

Also in the present embodiment, balloon 20 as the shock absorber defines a plurality of ventilation holes 22 vertically passing through balloon 20, each of the plurality of rotor units 30 is disposed in a different one of the plurality of ventilation holes 22, and each of the plurality of rudders 34 is disposed in a different one of the plurality of ventilation holes 22.

As described above, since pairs of rotor units 30 and rudders 34 are disposed in the respective ventilation holes 22, it becomes possible to easily adjust the flow directions of air currents generated by rotor units 30, using rudders 34 corresponding thereto.

Also in the present embodiment, each of the plurality of rudders 34 is disposed in an orientation in which axis of rotation 37 of each of the plurality of rudders 34 is along line PQ that connects central axis P of aircraft 10 and the center point (central axis Q) of the corresponding one of the plurality of rotor units 30. Accordingly, it becomes easy for rudders 34 to generate a vertical thrust with respect to line PQ in the horizontal direction of aircraft 10. As such, by rotating the plurality of rudders 34 independently, it becomes easy to achieve linear motion or rotational motion (rotation) of aircraft 10 in horizontal directions.

Also in the present embodiment, when aircraft 10 travels in a horizontal direction, each of the plurality of rudders 34 tilts to an orientation in which an upstream portion located upstream of air current generated by a corresponding one of the plurality of rotor units 30 is positioned more forward relative to a direction of travel of aircraft 10 than a downstream portion located downstream of the air current. This makes it easy for aircraft 10 to linearly move in horizontal directions.

Also in the present embodiment, when aircraft 10 rotates, each of the plurality of rudders 34 tilts to an orientation in which an upstream portion located upstream of the air current generated by the corresponding one of the plurality of rotor units 30 is positioned more forward relative to a rotational direction of aircraft 10 than a downstream portion located downstream of the air current. This makes it easy for aircraft 10 to make rotational motions (rotations) in horizontal directions.

Also in the present embodiment, when aircraft 10 rotates, the plurality of rudders 34 tilt toward an identical direction when the plurality of rudders 34 are viewed from the predetermined reference point. Stated differently, since the plurality of rudders 34 are capable of exerting a thrust from the identical direction out of vertical directions with respect to line PQ, it becomes easy for aircraft 10 to rotate about central axis P of aircraft 10 as an axis of rotation.

Also, the aircraft according to the present embodiment further includes; receiver 41a that receives a command signal transmitted from a radio remote control operated by an operator; first controller 41b that controls the number of rotations of the plurality of rotor units 30 in accordance with the command signal received by receiver 41a; and second controller 41c that controls tilting of the plurality of rudders 30 in accordance with the command signal received by receiver 41a. As just described, aircraft 10 separately includes first controller 41b that controls the number of rotations of the plurality of rotor units 30, and second controller 41c that controls the tilting of the plurality of rudders 34. This configuration enables the use of an existing controller utilized, for example, in the aircraft disclosed in PLT 1 as first controller 41b, thereby reducing the cost incurred for controller 41.

Also in the present embodiment, the plurality of rudders 34 are disposed at bottom end portions of the plurality of ventilation holes 22. As such, the plurality of rudders 34 are disposed downstream of rotor units 30 that generate downward air currents for the ascent of aircraft 10. Accordingly, it becomes possible to effectively change the flow directions of air currents generated by rotor units 30.

Also in the present embodiment, the bottom ends of the plurality of ventilation holes 22 each have a shape that gradually expands downward in cross sectional area. As such, even after the flows of air currents have been changed by the plurality of rudders 34 to flow diagonally, it is possible to secure a sufficient cross sectional area of a passageway through which each of such air currents at the downstream portion flows. Accordingly, it becomes possible for aircraft 10 to effectively make linear motion or rotational motion along horizontal directions.

Moreover, spaces filled with gas such as helium are formed in balloon 20 in regions between rotor units 30 in addition to in a region surrounding all rotor units 30 disposed in predetermined locations. Thus, with Embodiment 1, sufficient inner volumetric capacity can be secured in balloon 20, thereby reducing the need to increase the size of balloon 20.

Moreover, when aircraft 10 includes a plurality of rotor units 30, in order to stabilize flight of aircraft 10, the plurality of rotor units 30 are preferably spaced apart by a given distance. However, as described above, gas chambers filled with gas such as helium are also provided in regions between rotor units 30 with balloon 20 according to Embodiment 1. Thus, according to Embodiment 1, a sufficient gas chamber capacity can be secured without enlarging aircraft 10, and sufficient distance between rotor units 30 can be secured. This makes it possible to stabilize flight of aircraft 10.

Moreover, in Embodiment 1, aircraft 10 flies using both the buoyant force of the gas filling balloon 20 and the buoyant force of air current generated by rotor units 30. As such, compared to when just the buoyant force resulting from rotor units 30 running is used, energy such as power needed to drive rotor units 30 can be saved, thereby increasing the flight time aircraft 10 is capable of.

Moreover, in Embodiment 1, balloon 20 has a low profile.

This low profile shape makes it less likely that aircraft 10 will tilt relative to the axis of symmetry (central axis P) of balloon 20 mid-flight, resulting in a more stable flight of aircraft 10.

Moreover, in Embodiment 1, rotor units 30 and ventilation holes 22 in which rotor units 30 are installed are located near the peripheral edge of balloon 20.

This makes it possible to secure sufficient distance between rotor units 30 in aircraft 10. Thus, with Embodiment 1, flight of aircraft 10 can be stabilized by securing sufficient distance between rotor units 30.

Moreover, in Embodiment 1, balloon 20 gradually decreases in height from its central region toward its peripheral edge.

This gives balloon 20 a streamlined shape when viewed from the side. Thus, with Embodiment 1, it is possible to reduce the resistance of aircraft 10 to air mid-flight. Moreover, when ventilation holes 22 are arranged at intervals of a predetermined angle about the vertically extending central axis of balloon 20, ventilation holes 22 are located at relatively slim portions of balloon 20, making it possible to keep the lengths of ventilation holes 22 relatively short. The shorter the lengths of ventilation holes 22, the less the loss in air pressure is as air passes through ventilation holes 22. Thus, in this case, a sufficient amount of air flow through ventilation holes 22 can be secured which makes it possible to secure sufficient propulsion by rotor units 30.

Moreover, in Embodiment 1, connector 25 is provided in the central region of balloon 20 with one end connected to the top portion of balloon 20 and the other end connected to the bottom portion of balloon 20.

Stated differently, the top portion and the bottom portion in the central region of balloon 20 are connected via connector 25. This makes it easier for balloon 20 to maintain a desirable shape, such as a low profile shape. When the shape of balloon 20 is stable, ventilation holes 22 formed in balloon 20 are also stable, making it possible to achieve actual ventilation holes 22 similar to their design shape. Thus, a sufficient amount of air flow through ventilation holes 22 can be secured which in turn makes it possible to secure sufficient propulsion by rotor units 30. Moreover, stabilizing the shape of ventilation holes 22 formed in balloon 20 makes it easier to approximately match the shapes of all ventilation holes 22. This further equalizes the amount of air flowing through ventilation holes 22, which stabilizes flight of aircraft 10.

Moreover, in Embodiment 1, connector 25 has a tubular shape.

As such, the central regions of the top and bottom portions of balloon 20 (i.e., the regions surrounding central axis P of balloon 20) are connected to one another via tubular connector 25, across the entire perimeter of the central regions. Thus, with Embodiment 1, it is further easier for balloon 20 to maintain a desirable shape.

Moreover, in Embodiment 1, the space inside connector 25 is in communication with the space external to balloon 20.

As such, air fills the space inside connector 25 rather than gas for exerting buoyant force, such as helium.

Moreover, in Embodiment 1, each ventilation hole 22 has a shape that gradually expands in cross sectional area from the vertical central region toward the top end portion and from the vertical central region toward the bottom end portion.

Giving ventilation holes 22 such a shape reduces a loss in air pressure as air flows into ventilation holes 22 and a loss in air pressure as air flows out of ventilation holes 22. As such, even when rotor units 30 generate a small amount of air, a sufficient amount of air flow through ventilation holes 22 can be secured which makes it possible to secure sufficient propulsion by rotor units 30. Thus, in order to obtain the same propulsion, the energy consumed by rotor unit 30 can be reduced.

Moreover, in Embodiment 1, balloon 20 gradually decreases in height from its central region toward its peripheral edge, and with respect to each ventilation hole 22, the height h measured near the peripheral edge of balloon 20 is less than the height H measured near the central region of balloon 20.

With this, in each ventilation hole 22 in balloon 20, air flows into ventilation hole 22 from a direction originating from the peripheral edge of balloon 20 and exits ventilation hole 22 in a direction heading toward the peripheral edge of balloon 20. As a result, air flowing into one ventilation hole 22 can be inhibited from interfering with air flowing into another ventilation hole 22, and air flowing out of one ventilation hole 22 can be inhibited from interfering with air flowing out of another ventilation hole 22. Thus, with Embodiment 1, disruption of airflow due to interference of air flowing into and out of ventilation holes 22 can be inhibited, which stabilizes flight of aircraft 10.

Moreover, in Embodiment 1, rotor units 30 are disposed in the vertical central regions of ventilation holes 22. Stated differently, rotor units 30 are disposed to overlap center plane M passing through the vertical center of balloon 20.

As such, air flowing from the top of ventilation hole 22 toward rotor unit 30 and air flowing from rotor unit 30 toward the bottom of ventilation hole 22 can be stabilized, which stabilizes flight of aircraft 10.

Moreover, in Embodiment 1, ventilation holes 22 are arranged at intervals of a predetermined angle about the vertically extending central axis P of balloon 20.

Since rotor units 30 are therefore disposed at intervals of a predetermined angle about central axis P of balloon 20 and blow air downward, flight of aircraft 10 can be stabilized.

Moreover, in Embodiment 1, balloon 20 has rotational symmetry about a vertically extending line.

As such, the working point of the buoyant force of the gas filling balloon 20 is located on the axis of symmetry (i.e., central axis P) of balloon 20. As such, aircraft 10 can be inhibited from tilting mid-flight (here, tilt more specifically means change in orientation relative to vertically extending central axis P of balloon 20), which stabilizes flight of aircraft 10.

Moreover, in Embodiment 1, reference curve sections 23, which are equal in number to ventilation holes 22, and small curvature radius sections 24, which are also equal in number to ventilation holes 22 and have a smaller radius of curvature than reference curve sections 23, are alternately arranged along the peripheral edge of balloon 20 in a top view. Small curvature radius sections 24 are located at an outward side of ventilation holes 22 in one-to-one correspondence.

Here, tension working in sections of the peripheral edge of balloon 20 in a top view near ventilation holes 22 is lower than tension working in sections of the peripheral edge of balloon 20 in a top view further away from ventilation holes 22. This is because tension is working on portions of balloon 20 that form the walls of ventilation holes 22. When tension working on balloon 20 is regionally low, wrinkles easily form where working tension is low.

In light of this, in Embodiment 1, the radius of curvature of sections of the peripheral edge of balloon 20 in a top view near ventilation holes 22 is less than the radius of curvature of sections of the peripheral edge of balloon 20 in a top view further from ventilation holes 22. As such, the difference between tension working in sections of the peripheral edge of balloon 20 in a top view near ventilation holes 22 and tension working in sections of the peripheral edge of balloon 20 in a top view further away from ventilation holes 22 can be reduced. Accordingly, with Embodiment 1, wrinkles can be kept from forming in balloon 20, and the aesthetics of balloon 20 can be maintained.

Moreover, in Embodiment 1, onboard devices are housed in the space inside connector 25. The housed onboard devices include at least controller 41 that controls rotor units 30 and battery 42 that supplies power to rotor units 30.

The space inside connector 25 is in communication with the space external to balloon 20. As such, gas for providing buoyancy, such as helium, can be kept from expelling from balloon 20, and maintenance such as changing of battery 42 disposed in the space inside connector 25 can be done.

Moreover, in Embodiment 1, onboard devices are disposed at the bottom end of the space inside connector 25.

As such, the center of gravity of aircraft 10 can be lowered, thereby stabilizing flight of aircraft 10.

Moreover, in Embodiment 1, connector 25 is light-transmissive and houses in the space therein luminous body 46.

In Embodiment 1, light emitted by luminous body 46 passes through the light-transmissive connector 25, whereby it is emitted outside of connector 25. As such, if the outer layer of balloon 20 is made of a semitransparent material, for example, light emitted by luminous body 46 will strike the inner surface of balloon 20, whereby the color of the entire balloon 20 can be changed to the color of light emitted by luminous body 46. Thus, with Embodiment 1, the color of balloon 20 can be changed mid-flight to easily achieve a dramatic effect, for example.

Note that in Embodiment 1, the gas filling gas chamber 21 is exemplified as a gas that provides buoyancy, such as helium, but if flight is achievable with the buoyant force exerted by rotor units 30 alone, gas filling gas chamber 21 may be a gas that does not provide buoyancy, such as air. In this case, the load placed on rotor units 30 increases since balloon 20 does not provide any buoyancy itself, but the ascent and descent speed of aircraft 10 is more controllable. Furthermore, costs incurred from using gas can be saved.

### Variations of Embodiment 1

### Variation 1

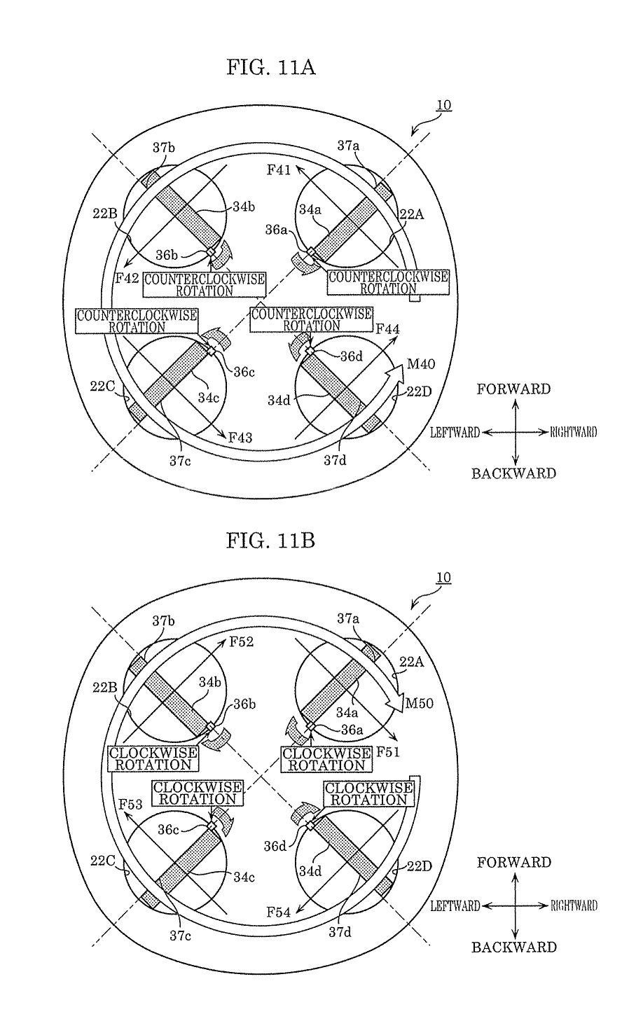

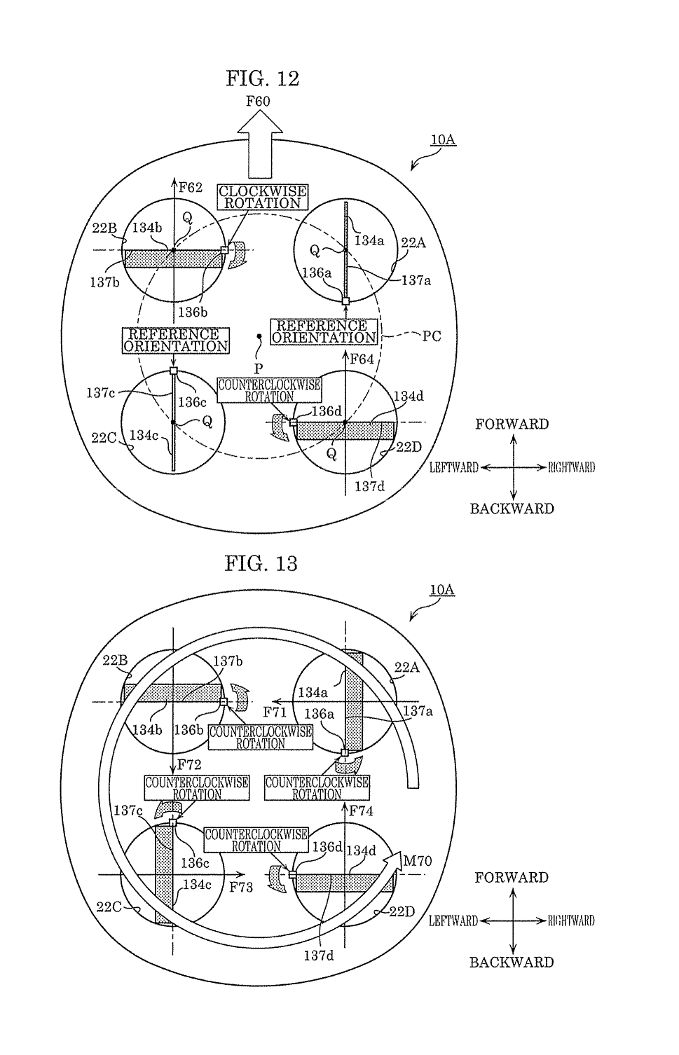

In aircraft 10 according to the embodiment described above, each of a plurality of rudders 34 is disposed in an orientation in which axis of rotation 37 of each rudder 34 is along line PQ that connects central axis P of aircraft 10 and central axis Q of ventilation hole 22 in which such rudder 34 is included. However, the present disclosure is not limited to this example. As illustrated in FIG. 12 and FIG. 13, the aircraft is simply required to have a configuration in which an axis of rotation of each of a plurality of rudders 134a to 134b is disposed in an orientation in which each axis of rotation intersects a virtual circle (pitch circle PC) centered about central axis P of aircraft 10A, along a circumferential direction of the virtual circle.

FIG. 12 is a diagram illustrating a state of the aircraft according to Variation 1 of Embodiment 1 when the aircraft is under flight control for forward horizontal linear motion. FIG. 13 is a diagram illustrating a state of the aircraft according to Variation 1 of Embodiment 1 when the aircraft is under flight control for counterclockwise horizontal rotational motion.

Note that FIG. 12 and FIG. 13 omit the illustration of rotor units 30 of aircraft 10A. Also note that rudder 134a and actuator 136a are disposed in ventilation hole 22 located at the right front side of aircraft 10A. Rudder 134b and actuator 136b are disposed in ventilation hole 22 located at the left front side of aircraft 10A. Rudder 134c and actuator 136c are disposed in ventilation hole 22 located at the left back side of aircraft 10A. Rudder 134d and actuator 136d are disposed in ventilation hole 22 located at the right back side of aircraft 10A.

More specifically, as illustrated in FIG. 12, rudders 134a and 134c are disposed along the back-and-forth direction, whereas rudders 134b and 134d are disposed along the left-right direction. Actuators 136a to 136d are disposed at those edges of the corresponding rudders 134a to 134b that are closer to central axis P of aircraft 10A.

Note that components of aircraft 10A other than rudders 134a to 134d will be described as the same components as the components of aircraft 10.

### (Linear Motion)

Hereinafter, flight control will be described for the case where aircraft 10A moves linearly in the forward horizontal direction.

When receiver 41a receives a command signal indicating forward horizontal linear motion, second controller 41c causes rudders 134a and 134c, which are disposed along the back-and-forth direction of aircraft 10A as illustrated in FIG. 12, to remain in the reference orientation, without causing actuators 136a and 136c of rudders 134a and 134c to rotate. In this case, second controller 41c causes rudder 134b to rotate clockwise by causing actuator 136b of rudder 134b to rotate clockwise out of rudders 134b and 134d disposed along the left-right direction of aircraft 10A. Furthermore, second controller 41c causes rudder 134d to rotate counterclockwise by causing actuator 136d of rudder 134d to rotate counterclockwise out of rudders 134b and 134d.

Accordingly, rudders 134b and 134d are tilted to an orientation in which their downstream portions face backward relative to the direction of travel of aircraft 10A. More specifically, of rudders 134a to 134b, rudders 134b and 134d, which are aligned across the central axis of aircraft 10A, are tilted to an orientation in which their downstream portions are positioned backward relative to axes of rotation 137b and 137d, which are their upstream portions. As such, forward thrusts F62 and F64, which are opposite to the side toward which rudders 134b and 134d are tilted, will act on ventilation holes 22B and 22D, respectively.

Since rudders 134a and 134c remain in the reference orientation, no vertical thrust will act on rudders 134a and 134c. Stated differently, since only forward thrusts F62 and F64 act on aircraft 10A, forward resultant force F60 will act on aircraft 10A.

Note that a description of the case where aircraft 10A moves linearly in the backward horizontal direction will be omitted, for the rotational directions of actuators 136a to 136d of rudders 134a to 134d when aircraft 10A moves linearly in the forward horizontal direction are simply required to be reversed.

Also note that when aircraft 10A moves linearly in the rightward horizontal direction, controls of rudders aligned along the left-right direction are simply required to be reversed relative to the case where the aircraft moves linearly in the forward horizontal direction. Stated differently, controls of rudders 134a and 134b aligned along the left-right direction are reversed, and controls of rudders 134c and 134d aligned along the left-right direction are reversed. More specifically, when aircraft 10A moves linearly in the rightward horizontal direction, control to be performed on rudder 134a when the aircraft moves linearly in the forward horizontal direction is applied to rudder 134b (control for the reference orientation), and control to be performed on rudder 134b when the aircraft moves linearly in the forward horizontal direction is applied to rudder 134a (control for clockwise rotation). Likewise, control to be performed on rudder 134c when the aircraft moves linearly in the forward horizontal direction is applied to rudder 134d (control for the reference orientation), and control to be performed on rudder 134d when the aircraft moves linearly in the forward horizontal direction is applied to rudder 134c (control for counterclockwise rotation). Accordingly, aircraft 10A can move linearly in the rightward horizontal direction. Similarly, when aircraft 10A moves linearly in the leftward horizontal direction, controls to be performed on rudders aligned in the back-front direction are simply required to be reversed relative to the case where the aircraft moves linearly in the rightward horizontal direction.

### (Rotational Motion)

Hereinafter, flight control will be described for the case where aircraft 10A rotates along horizontal directions. The following describes flight control for rotational motion when aircraft 10A rotates about central axis P of aircraft 10A as an axis of rotation.

The following describes flight control for the case where aircraft 10A rotates horizontally counterclockwise.

When receiver 41a receives a command signal indicating counterclockwise horizontal rotation, second controller 41c causes rudders 134a to 134d to rotate counterclockwise, by causing actuators 136a to 163d of rudders 134a to 134b of aircraft 10A to rotate counterclockwise, as illustrated in FIG. 13.

Accordingly, rudders 134a to 134d are tilted to an orientation in which their downstream portions face backward relative to the direction of rotation. More specifically, rudder 134a is tilted to an orientation in which its downstream portion is positioned rightward with respect to axis of rotation 137a, which is its upstream portion. As such, thrust F71 in the leftward direction, which is opposite to the side toward which rudder 134a is tilted, will act on ventilation hole 22A.

Also, rudder 134b is tilted to an orientation in which its downstream portion is positioned forward with respect to axis of rotation 137b, which is its upstream portion. As such, thrust F72 in the backward direction, which is opposite to the side toward which rudder 134b is tilted, will act on ventilation hole 22B.

Also, rudder 134c is tilted to an orientation in which its downstream portion is positioned leftward with respect to axis of rotation 137c, which is its upstream portion. As such, thrust F73 in the rightward direction, which is opposite to the side toward which rudder 134c is tilted, will act on ventilation hole 22C.

Also, rudder 134d is tilted to an orientation in which its downstream portion is positioned backward with respect to axis of rotation 137d, which is its upstream portion. As such, thrust F74 in the forward direction, which is opposite to the side toward which rudder 134d is tilted, will act on ventilation hole 22D.

A total sum of thrusts F71 to F74 is zero, and thus aircraft 10A will not move linearly.

Meanwhile, each of thrusts F71 to F74 is in the direction of counterclockwise rotation about central axis P of aircraft 10A serving as an axis of rotation, and thus rotational moment M70 for counterclockwise rotation about central axis P will act on aircraft 10A.

Note that when aircraft 10A rotates horizontally clockwise, aircraft 10A can be rotated clockwise by reversing the rotational directions of actuators 136a to 136d of rudders 134a to 134d when aircraft 10 rotates horizontally counterclockwise.

### Variation 2

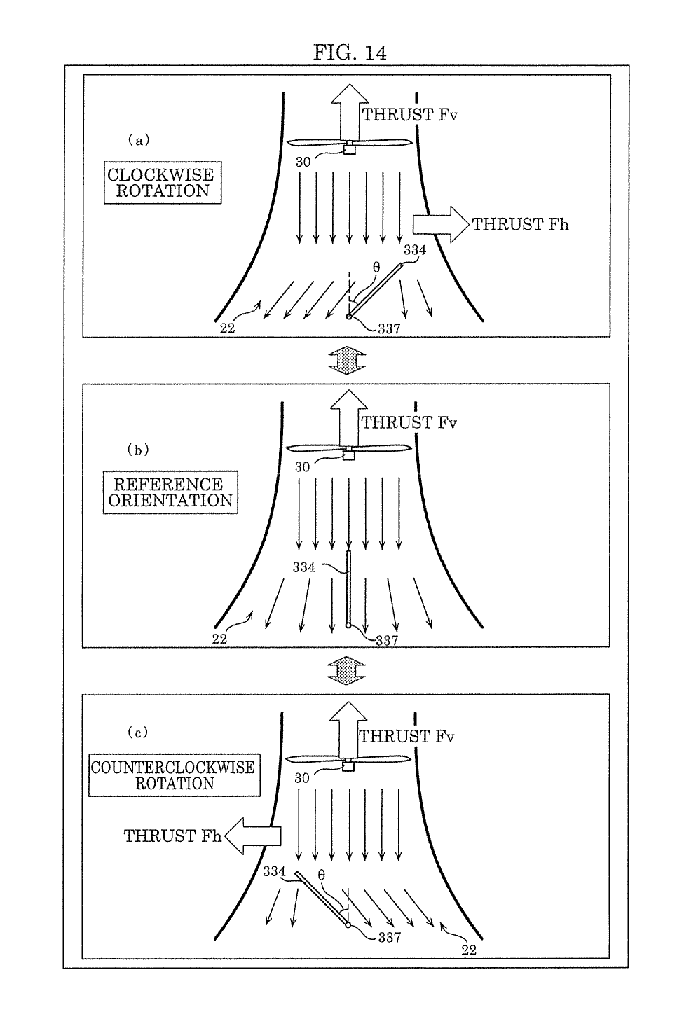

In the above embodiment, a plurality of rudders 34 rotate about their upstream portions (upper long sides) located upstream (rotor units 30 sides) as axes of rotation 37, but the present disclosure is not limited to this example. As illustrated in FIG. 14, the present disclosure may have a configuration, for example, in which a plurality of rudders 334 rotate about their downstream portions (bottom long sides) located downstream (at the opposite sides of rotor units 30) as axes of rotation 337.

FIG. 14 is a schematic diagram showing an example cross section of a ventilation hole of the aircraft according to Variation 2 of Embodiment 1 viewed from the central axis of the aircraft.

As illustrated in (b) in FIG. 14, when rudder 334 is in the reference orientation, air current generated by rotor unit 30 flows inside ventilation hole 22 from the top to the bottom. For this reason, vertical thrust Fv will act on the aircraft, whereas no horizontal thrust will act on the aircraft.

As illustrated in (a) in FIG. 14, when rudder 334 is rotated clockwise to tilt rightward on the drawing by a predetermined angle 6 with respect to axis of rotation 337, air current generated by rotor unit 30 flows along a direction toward which rudder 334 has been tilted. More specifically, the flow direction of the air current has been changed by rudder 334, as a result of which the air current flows diagonally to the left, which is opposite to the right toward which rudder 334 is tilted. Accordingly, not only vertical thrust Fv but also rightward horizontal thrust Fh, which is in the same direction, i.e., the right direction toward which rudder 334 is tilted, will act on the aircraft.

Similarly, as illustrated in (c) in FIG. 14, when rudder 334 is rotated counterclockwise to tilt leftward on the drawing by a predetermined angle θ with respect to axis of rotation 337, air current generated by rotor unit 30 flows along a direction toward which rudder 334 has been tilted. More specifically, the flow direction of the air current has been changed by rudder 334, as a result of which the air current flows diagonally to the right, which is opposite to the left toward which rudder 334 is tilted. Accordingly, not only vertical thrust Fv but also leftward horizontal thrust Fh, which is in the same direction, i.e., the left direction toward which rudder 334 is tilted, will act on the aircraft.

As described above, the rotational direction of rudder 334 and the direction of a horizontal thrust acting on the aircraft are in an opposite relationship with rudder 34 of Embodiment 1. As such, in order to apply to rudder 334 the horizontal motions of the aircraft described in Embodiment 1, the controls intended for the respective motions are simply read as follows: when rotating rudder 34 counterclockwise, rudder 334 is rotated clockwise; when rotating rudder 34 clockwise, rudder 334 is rotated counterclockwise; and when causing rudder 34 to remain in the reference orientation, rudder 334 is caused to remain in the reference orientation.

### Variation 3

In the above embodiment, axis of rotation 37 of each rudder 34 is disposed to tilt horizontally such that its outer end located in a more peripheral position relative to aircraft 10 is positioned higher than its inner end located in a more inward position relative to aircraft 10, but the present disclosure is not limited to this example. For example, each rudder may be disposed such that its axis of rotation is horizontally parallel. In this case, each rudder may be shaped so that its outer short side located in a more peripheral position relative to the aircraft is shorter than its inner short side located in a more inward position relative to the aircraft, and the bottom long side of each rudder is shaped to match the shape of the bottom end of ventilation hole 22 of aircraft 10. Stated differently, the bottom long side of each rudder may have a linear shape that is horizontally tilted such that its outer end located in a more peripheral position relative to aircraft 10 is positioned higher than its inner end located in a more inward position relative to the aircraft 10, or may have an arc-like shape that matches the shape of ventilation hole 22.

### Variation 4

In the above embodiment, in the case of flight control for the respective horizontal directions, thrusts in the respective horizontal directions are obtained by adjusting the tilting of rudders 34, but the present disclosure does not require the aircraft to maintain its horizontal height when travelling. Stated differently, flight control for the respective horizontal directions may allow the aircraft to ascend and descend while travelling in the respective horizontal directions.

### Variation 5

In the above embodiment, in the case of horizontal linear motion, the tilting of rudders 34 are controlled after the orientation of aircraft 10 has been tilted, but the present disclosure is not limited to this example. For example, the aircraft 10 may linearly move in a horizontal direction by tilting a plurality of rudders 34, without variations in the speed of rotations of rotor units 30 aligned in the direction of travel. Accordingly, it becomes possible for aircraft 10 to move linearly in horizontal directions, while maintaining its horizontal orientation.

As described above, concerning linear motion and rotational motion of aircraft 10, there is a method for controlling the number of rotations of a plurality of rotor units 30, and there is a method for controlling the tilting of a plurality of rudders 34. As such, by combining the method for controlling the number of rotations of rotor units 30 with the method for controlling the tilting of rudders 34, it is possible, for example, to perform first to third controls described below.

As the first control, for linear motion and rotational motion, the number of rotations of all rotor units 30 is set to the same value to control the tilting of a plurality of rudders 34. Stated differently, in the first control, only the tilting of a plurality of rudders 34 are controlled for linear motion and rotational motion.

As the second control, for linear motion, the number of rotations of rotor unit 30 located forward in the direction of travel is set to be greater than the number of rotations of rotor unit 30 located backward in the direction of travel, and the tilting of a plurality of rudders 34 are controlled. For rotational motion, the tilting of a plurality of rudders 34 are controlled. Note that, in the second control, the number of rotations of a plurality of rotor units 30 may be different from one another for rotational motion.

As the third control, for linear motion, the number of rotations of rotor unit 30 located backward in the direction of travel is only set to be greater than the number of rotations of rotor unit 30 located forward in the direction of travel, and for rotational motion, the tilting of a plurality of rudders 34 are only controlled. In the third control, the tilting of a plurality of rudders 34 are not controlled for linear motion. Note that for rotational motion, the number of rotations of a plurality of rotor units 30 may be different from one another or may be the same for all rotor units.

### Variation 6

In aircraft 10 according to the above embodiment, each rudder 34 is disposed at the bottom end portion of ventilation hole 22, but each rudder 34 may be disposed at the top end portion of ventilation hole 22. In this case, for example, the buoyant force of the gas filling balloon 20 is greater than the gravity acting on the weight of aircraft 10 (i.e., the weight of the components of aircraft 10 excluding gas). The orientation of aircraft 10 is controlled by rotor units 30 rotating in the reverse direction to generate upward air currents. In the case of the aircraft with a structure in which rotor units 30 generate upward air currents as just described, flight control for the respective horizontal directions are performed by adjusting the tilting of rudders 34 that are disposed at those top end portions of ventilation holes 22 that are located downstream of rotor units 30.

Note that even when the buoyant force of the gas filling balloon 20 is not greater than the gravity acting on the weight of aircraft 10, there is a possible case, for example, that the rotor units are controlled so that one or more of a plurality of rotor units 30 rotate in the forward direction, while another one or more of a plurality of rotator units 30 rotate in the reverse direction. In this case, rudders 34 may be disposed at both the bottom and top end portions of ventilation holes.

### Variation 7

In the above embodiment, axis of rotation 37 of each rudder 34 is fixed, but the present disclosure is not limited to this example. For example, each rudder 34 may be provided in ventilation hole 22 in a manner that axis of rotation 37 as a first axis of rotation is rotatable about a second axis of rotation centered about central axis Q of ventilation hole 22 as an axis of rotation. This structure allows each rudder 34 to rotate also about the second axis of rotation. Accordingly, by changing the directions of a plurality of rudders 34 rotating about the second axes of rotation depending on a horizontal direction in which aircraft 10 is desired to move, it becomes possible for aircraft 10 to travel in a desired horizontal direction, while maintaining its horizontal orientation (i.e., without the need for aircraft 10 turning).

Note that in the case where air conditioning plates 35 are provided, air conditioning plates 35 may also rotate about the second axes of rotation together with rudders 34.

### Variation 8

In aircraft 10 according to the above embodiment, first controller 41b and second controller 41c control the number of rotations of rotor units 30 and adjust the tilting of rudders 34, respectively, in accordance with command signals received by receiver 41a, but the present disclosure is not limited to this example. For example, in the case where aircraft 10 includes a position information acquisition device such as a GPS receiver and thus is capable of obtaining information on its destination, first controller 41b and second controller 41c may perform the respective controls in accordance with a flight route to the acquired destination. Note that flight route may be included in information indicating a flight destination. Also note that controller 41 may determine a flight route since the destination and the current position of the aircraft.

### Variation 9

Flight control for linear motion and rotational motion (rotation) of aircraft 10 in horizontal directions have been described above. However, by combing controls for linear motion and rotational motion, the present disclosure may be applicable to flight control according to which a horizontal orientation of aircraft 10 is changed while aircraft 10 is moving linearly, or may be applicable to flight control according to which aircraft 10 travels and turns on a curving flight route

### Embodiment 2

Hereinafter aircraft 10B according to Embodiment 2 will be described. Aircraft 10B according to Embodiment 2 is achieved by rearranging rotor units 30 in aircraft 10 according to Embodiment 1.

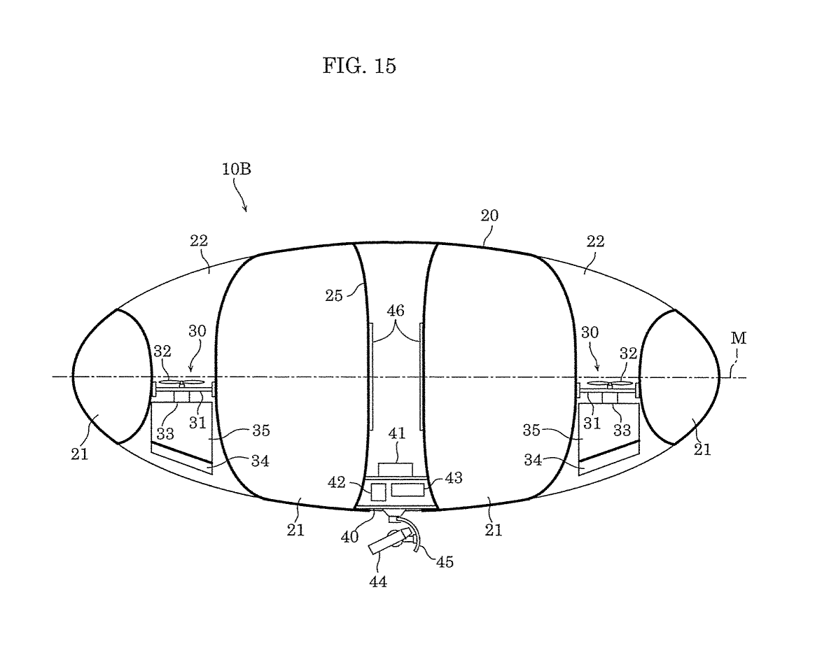

FIG. 15 is a cross sectional view of the aircraft according to Embodiment 2 and corresponds to FIG. 3.

As illustrated in FIG. 15, rotor units 30 equipped in aircraft 10B according to Embodiment 2 are disposed below center plane M passing through the vertical center of balloon 20. Stated differently, the entirety of each rotor unit 30 is disposed below center plane M of balloon 20. In this way, rotor unit 30 may be disposed in each ventilation hole 22 of aircraft 10B in a region ranging from center plane M of balloon 20 to the bottom end of ventilation hole 22.

Accordingly, it becomes possible to locate the center of gravity of aircraft 10B at a lower position, and thus to inhibit aircraft 10B from overturning and reversing, thereby effectively stabilizing the orientation of aircraft 10B.

### Embodiment 3

Hereinafter aircraft 10C according to Embodiment 3 will be described. Aircraft 10C according to Embodiment 3 is achieved by changing out balloon 20 in aircraft 10 according to Embodiment 1 for balloon 20A.

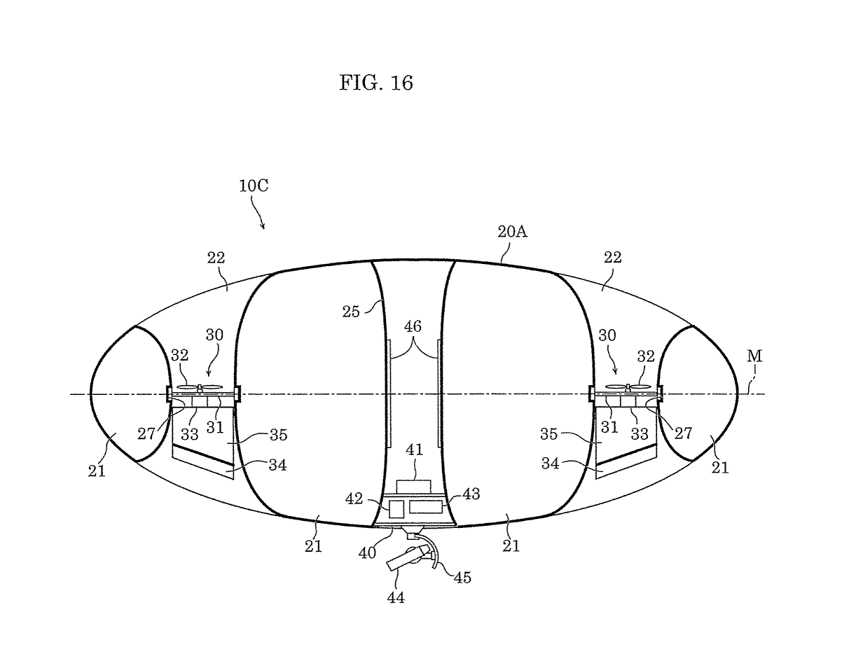

FIG. 16 is a cross sectional view of the aircraft according to Embodiment 3 and corresponds to FIG. 3.

As illustrated in FIG. 16, balloon 20A according to Embodiment 3 includes indentations 27 for installation of rotor units 30 in sections forming ventilation holes 22. Indentations 27 are indentations formed in sections of balloon 20A forming ventilation holes 22. A single indentation 27 is formed in each ventilation hole 22. Moreover, indentation 27 is located around the entire perimeter of ventilation hole 22 where rotor unit 30 is attached (in Embodiment 3, indentation 27 is located in the vertical central region of ventilation hole 22).

The outer peripheral portion of frame 31 of rotor unit 30 fits into indentation 27 of balloon 20A. As such, rotor unit 30 can easily be positioned when attaching rotor unit 30 to balloon 20A. Stated differently, indentation 27 acts as a guide for attaching rotor unit 30 to balloon 20A. Moreover, indentation 27 is as deep as frame 31 of rotor unit 30 is thick, which allows frame 31 to sit flush with the surface defining ventilation hole 22 in indentation 27. This allows for air to flow smoothly through ventilation hole 22.

### Embodiment 4

Hereinafter the aircraft according to Embodiment 4 will be described. The aircraft according to Embodiment 4 differs from aircraft 10 according to

Embodiment 1 in that the aircraft according to Embodiment 4 includes balloon 20B whose ventilation holes 22 differ in shape from ventilation holes 22 of balloon 20.

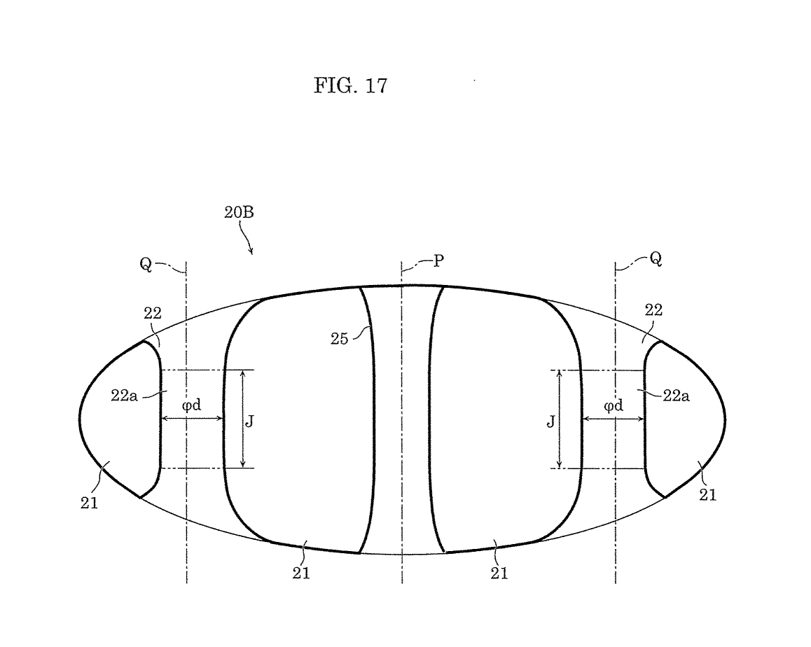

FIG. 17 is a cross sectional view of the balloon included in the aircraft according to Embodiment 4, and corresponds to FIG. 6.

As illustrated in FIG. 17, in balloon 20B according to Embodiment 4, the vertical central region of each ventilation hole 22 is configured of center tubular section 22a having a constant diameter throughout a predetermined length. Center tubular section 22a has a length J and a diameter φd. Ventilation hole 22 according to Embodiment 4 gradually increases in cross sectional area from the top end of center tubular section 22a toward the top end of ventilation hole 22, and gradually increases in cross sectional area from the bottom end of center tubular section 22a toward the bottom end of ventilation hole 22. With the aircraft according to Embodiment 4, rotor unit 30 is disposed in the vertical central region of each center tubular section 22a of balloon 20B.

### Embodiment 5

Hereinafter the aircraft according to Embodiment 5 will be described. The aircraft according to Embodiment 5 is achieved by changing out balloon 20 in aircraft 10 according to Embodiment 1 for balloon 20C.

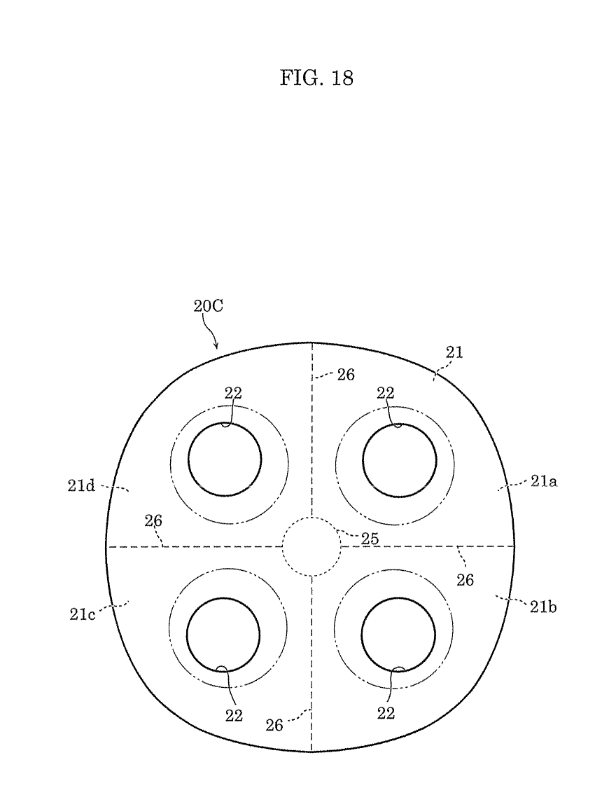

FIG. 18 is a plan view of the balloon included in the aircraft according to Embodiment 5.

As illustrated in FIG. 18, balloon 20C according to Embodiment 5 is balloon 20 according to Embodiment 1 further including bulkhead 26 that partitions gas chamber 21 into a plurality of regions. Bulkhead 26 according to Embodiment 5 extends vertically across gas chamber 21 to partition gas chamber 21 into four regions—region 21a, region 21b, region 21c, and region 21d.

Regions 21a through 21d of gas chamber 21 partitioned by bulkhead 26 are independent spaces not in communication with one another. As such, even if balloon 20C were to rupture and gas from one region, for example region 21a, were to leak out, the remaining regions 21b through 21d would still hold gas. Thus, even if balloon 20C were to rupture, balloon 20C would remain afloat by the buoyant force exerted by the gas remaining in balloon 20C, making it possible to prevent the aircraft from suddenly falling to the ground.

Note that the number of regions 21a through 21d illustrated in FIG. 18 is just one example. Moreover, the shape of bulkhead 26 illustrated in FIG. 18 is just one example as well. For example, bulkhead 26 may extend horizontally to partition gas chamber 21 into vertical chambers, and may surround the perimeter of the tubular connector 25 in a curved shape to partition gas chamber 21 in a circumferential manner. Moreover, bulkhead 26 may form a compact balloon housed within gas chamber 21. Moreover, regions 21a through 21d may be filled with different gases. For example, regions 21a and 21c may be filled with helium, and regions 21b and 21d may be filled with air. This makes it possible to reduce the amount of costly helium used.

### Embodiment 6

Hereinafter aircraft 10D according to Embodiment 6 will be described. Aircraft 10D according to Embodiment 6 mainly differs from aircraft 10 according to Embodiment 1 in that it further includes fixing component 50 and uses balloon 20D which has a different structural configuration than balloon 20 according to Embodiment 1. Hereinafter description will focus on the differences from aircraft 10 according to Embodiment 1.

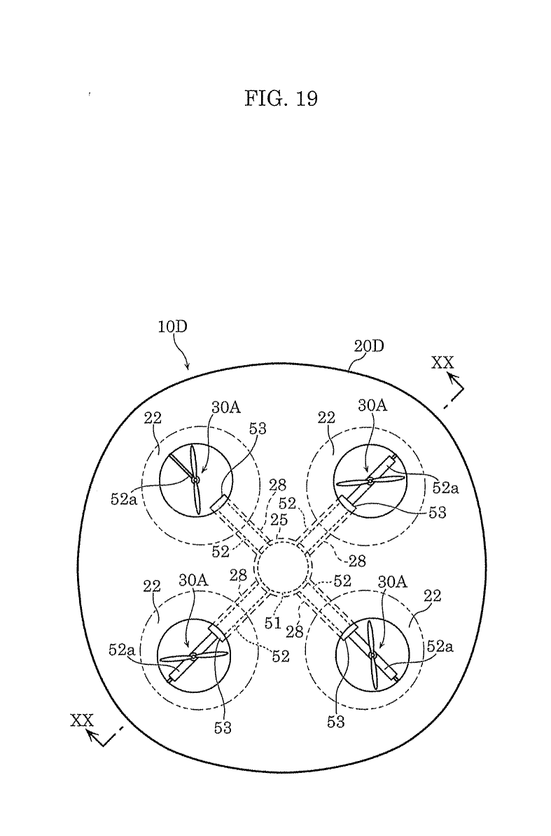

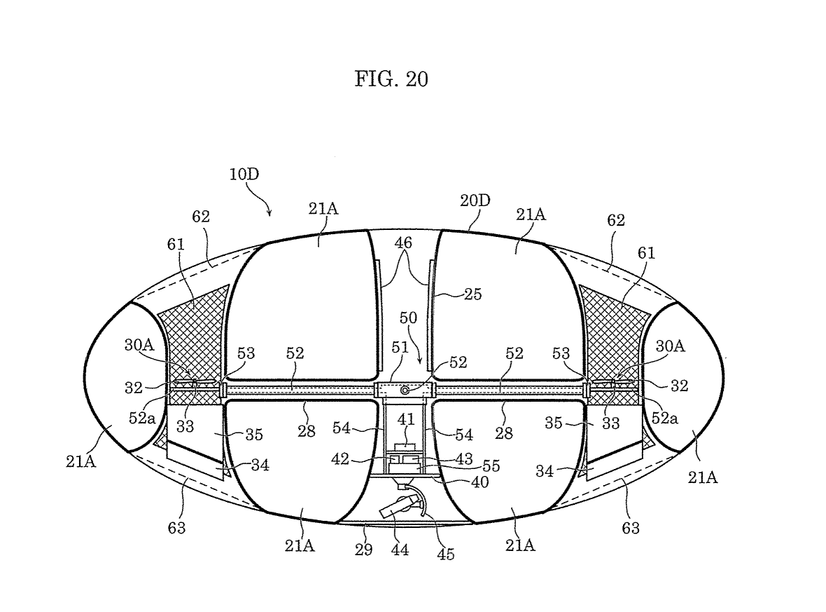

FIG. 19 is a plan view of the aircraft according to Embodiment 6. FIG. 20 is a cross sectional view of the aircraft according to Embodiment 6 and corresponds to FIG. 3.

As illustrated in FIG. 19 and FIG. 20, aircraft 10D according to Embodiment 6 includes fixing component 50.

Fixing component 50 fixes each of the plurality of rotor units 30A in a predetermined position in a top view and in an orientation in which axes of rotation of rotor units 30A are approximately vertical. Specifically, fixing component 50 includes main body 51, four arms 52, and two support components 54.

Main body 51 is disposed in the space inside connector 25, and has the shape of a hollow cylinder with a base at its top end. Stated differently, main body 51 has a hollow therein.

The four arms 52 are tubular components fixed to the sides of main body 51, and extend from the sides of main body 51 in four different directions. Here, the four different directions are the directions from the space inside connector 25 toward ventilation holes 22.

The four arms 52 include distal ends 52a that fix the four rotor units 30A in orientations in which axes of rotation of the rotor units 30A are approximately vertical. More specifically, the lower part of motor 33 of rotor unit 30A is fixed to distal end 52a.

The two support components 54 are fixed to the bottom of main body 51 and extend downward from main body 51. Disk 40, which supports the onboard devices, is attached to the bottom of the two support components 54. The two support components 54 support disk 40 in a location such that camera 44 fixed to disk 40 is housed in a space within connector 25.

Note that main body 51 includes through-holes at points where the four arms 52 are fixed to main body 51, and the through-holes are communicatively connected to spaces inside the four arms 52. These through-holes allow the space inside main body 51 and the space inside the four arms 52 to be in communication with one another. Electrical cabling (not shown in the drawings) for supplying power to rotor units 30A from battery 42 runs through the spaces inside the four arms 52. In other words, the four arms 52 also function as conduit for housing electrical cabling.

In addition to the onboard devices, disk 40 also supports container 55 that accommodates a weight. Stated differently, aircraft 10D includes container 55. Container 55 is box-shaped and defines a space in which a metal weight (such as a lead, copper, or alloy weight) can be housed. Note that the weight is not limited to a metal weight; a non-metal weight (such as sand) is also acceptable. The weights may be provided in predetermined units of weight (for example 1 gram to 10 gram units) to adjust the gross weight of aircraft 10D.

Since balloon 20D is made of an elastic material, determining the amount of gas required to fill gas chamber 21A (i.e., determining the volumetric capacity of gas chamber 21A) is difficult. As such, until gas chamber 21A of balloon 20D is filled with gas, estimating the exact amount of buoyant force that will be exerted by the gas is difficult.

Thus, by providing container 55, after gas chamber 21A of balloon 20D is filled with gas, weights can be added to or removed from container 55 to adjust the gross weight of aircraft 10D. As a result, as described in Embodiment 1, the gross weight of aircraft 10D can be adjusted such that the buoyant force of the gas filling balloon 20D is slightly less than the gross weight of aircraft 10D. Note that the amount of buoyant force exerted by the gas filling balloon 20D is set to be consistently greater than the gross weight of aircraft 10D in a state in which no weights are in container 55 even if there are inconsistencies in the volumetric capacities of gas chamber 21A in balloon 20D.

Although not specifically described in Embodiments 1 through 5, note that aircrafts 10 and 10A through 10C according to Embodiments 1 through 5 may also include container 55.

Moreover, the four arms 52 each include voltage regulator 53. Each voltage regulator 53 is an amp that regulates the voltage of the power for driving motor 33 included in rotor unit 30A disposed near a corresponding one of arms 52. The plurality of voltage regulators 53 are each disposed in a different one of the plurality of ventilation holes 22.

Balloon 20D includes ducts 28 to connect ventilation holes 22. More specifically, ducts 28 communicatively connect ventilation holes 22 with the space inside connector 25 located in the central region of balloon 20D in a top view. Each arm 52 of fixing component 50 is disposed inside a different duct 28. In other words, ducts 28 are spaces for housing arms 52. Fixing component 50 may be supported by balloon 20D from pressure from gas chamber 21A being imparted on arms 52 in ducts 28, and main body 51 may be fixed in a predetermined position in connector 25.

Moreover, balloon 20D includes window 29 in the lower region of connector 25. Window 29 is made of a transparent resin such as acrylic so camera 44 can photograph below balloon 20D. Moreover, window 29 may simply be an opening.

Tubular components 61 are each disposed in a different one of ventilation holes 22 of balloon 20D. Each tubular component 61 supports the surface defining ventilation hole 22 from inside ventilation hole 22 to prevent the path of air flow in ventilation hole 22 from narrowing. Tubular component 61 is, for example, metal wire mesh. Tubular component 61 is not limited to metal such as metal wire, and may be made of any material that allows it to support the surface defining ventilation hole 22 in an outward direction without blocking the flow of air, such as resin. Moreover, tubular component 61 is not required to be formed into a mesh, and may be sheet shaped into a hollow cylinder. Note that arms 52 pass through tubular component 61.

Moreover, protective nets 62 and 63 are provided at the top and bottom end portions of ventilation holes 22 of balloon 20D to inhibit contact with rotor units 30A disposed inside ventilation holes 22 in the event that an object contacts the top or bottom end portion of ventilation holes 22.

Unlike rotor units 30 according to Embodiment 1, since rotor units 30A are supported by fixing component 50 and tubular components 61, frame 31 may be omitted from the configuration.

### Advantageous Effects of Embodiment 6

In aircraft 10D according to Embodiment 6, fixing component 50 fixes each of the plurality of rotor units 30A in a predetermined position in a top view and in an orientation in which axes of rotation of rotor units 30A are approximately vertical. Balloon 20D includes ducts 28 in communication with the plurality of ventilation holes 22, and arms 52 of fixing component 50 are disposed inside ducts 28. As such, with fixing component 50, since rotor units 30A are fixed so as to be in predetermined positions relative to one another, and orientations of rotor units 30A are fixed such that their axes of rotation are approximately vertical, even if balloon 20D were to contact an object and balloon 20D were to be damaged, the relative positions and orientations of rotor units 30A would remain the same as before balloon 20D was damaged. As such, even if balloon 20D were to contact and be damaged by an object, it would still be possible to stably fly aircraft 10D.

Here, voltage regulators 53 are electrical parts that change the voltage of power from battery 42 to a voltage appropriate for motor 33, and as such, easily produce heat. However, since balloon 20D is made of a heat sensitive material, there is concern that balloon 20D may melt due to heat-generating parts.

With aircraft 10D according to Embodiment 6, since voltage regulators 53, which easily produce heat, are disposed in ventilation holes 22 through which air flows from rotor units 30A, voltage regulators 53 can be efficiently cooled by the air flow. Thus, damage resulting from balloon 20D melting from the heat from voltage regulators 53 and leakage of gas filling gas chamber 21A can be reduced.

Although not specifically described in Embodiment 1 through 5, note that aircrafts 10 and 10A through 10C according to Embodiments 1 through 5 (i.e., aircrafts 10 and 10A through 10C which do not include fixing component 50) include a voltage regulator for each rotor unit 30. Thus, aircrafts 10 and 10A through 10C also have the same above-described problem as aircraft 10D according to the present embodiment. Therefore, similar to aircraft 10D according to the present embodiment, disposing the voltage regulators in ventilation holes 22 of aircrafts 10 and 10A through 10C according to Embodiments 1 through 5 can be said to provide the same advantageous effect described above.

Since aircraft 10D according to the present embodiment includes tubular component 61 disposed in each ventilation hole 22, and tubular components 61 supports surfaces defining ventilation holes 22 to prevent ventilation holes 22 from narrowing, ventilation holes 22 can be easily maintained to have a desired shape. This makes it possible to achieve a desired air flow via rotor units 30A and stably fly aircraft 10D.

With aircraft 10D according to the present embodiment, the top and bottom of connector 25 are covered, and protective nets 62 and 63 are provided at the top and bottom of ventilation holes 22. Stated differently, since rotor units 30A, fixing component 50, and the onboard devices are covered by balloon 20D and protective nets 62 and 63, even if aircraft 10D were to crash into an object, balloon 20D and protective nets 62 and 63 would mitigate the impact. As such, damage to rotor units 30A, fixing component 50, and the onboard devices as well as damage to the object itself can be effectively reduced.

### Other Embodiments

As described above, techniques of the present disclosure have been described by way of example via embodiments. However, techniques of the present disclosure are not limited to the above embodiments; the techniques are applicable to embodiments resulting from various modifications, permutations, additions and omissions to and in the above embodiments.

Examples of such other embodiments will be described hereinafter.

In Embodiments 1 through 6 described above, aircrafts 10 and 10A through 10D include a shock absorber configured of a hollow balloon 20 or balloon 20A through 20D, but the shock absorber is not limited to this example. For example, the shock absorber may be configured of a solid material such as a sponge-like material or rubber. In other words, the shock absorber may be made of any material so long as the shock absorber can absorb an impact in the event of crashing into an object.

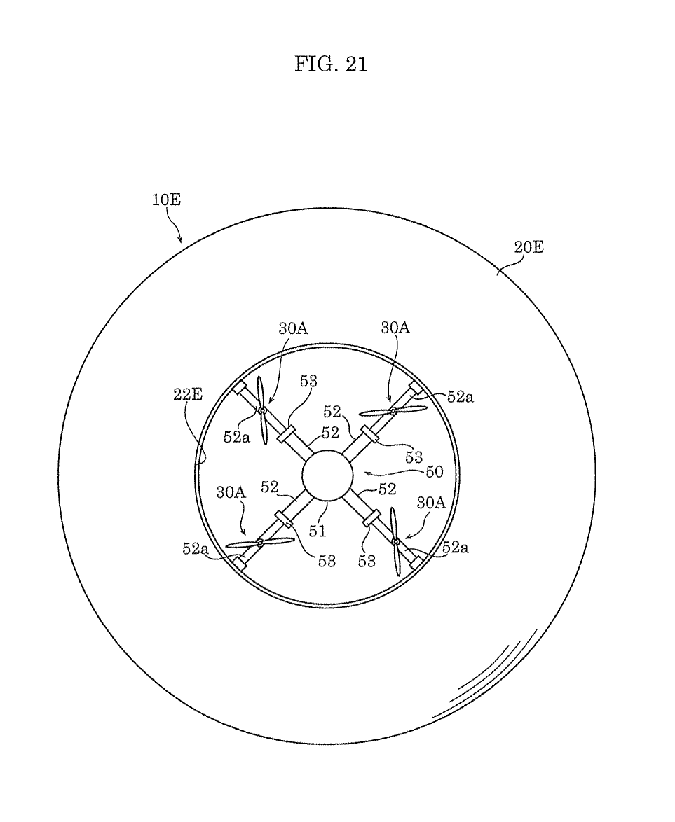

In Embodiments 1 through 6 described above, balloons 20 and 20A through 20D of aircrafts 10 and 10A through 10D include four ventilation holes 22, and rotor unit 30 or 30A is disposed in each of the four ventilation holes 22, but this configuration is merely an example. For example, as illustrated in FIG. 21, aircraft 10E including balloon 20E defining a single ventilation hole 22E, and fixing component 50 including four rotor units 30A disposed inside the single ventilation hole 22E is acceptable. Note that FIG. 21 is a plan view of an aircraft according to another embodiment.

Moreover, although not illustrated in the drawings, an aircraft including a balloon defining two ventilation holes, and two rotor units disposed in each of the two ventilation holes is also acceptable. Stated differently, an aircraft in which a plurality of rotor units are disposed in a single ventilation hole is acceptable.

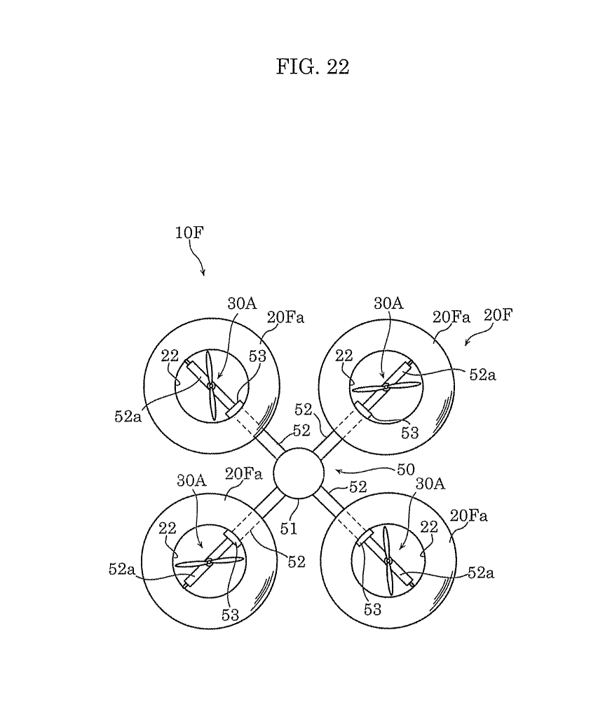

In Embodiments 1 through 6 described above and FIG. 21 illustrating another embodiment, aircrafts 10 and 10A through 10D include a single balloon 20 or balloon 20A through 20E, but the balloon is not limited to this example. For example, as illustrated in FIG. 22, balloon 20F including a plurality of (four) separate sub-balloons 20Fa (i.e., sub-shock absorbers) may be used. Note that FIG. 22 is a plan view of an aircraft according to another embodiment. Each of sub-balloons 20Fa defines a single ventilation hole 22 in which a single rotor unit 30A is disposed. Rotor units 30A disposed in ventilation holes 22 defined by the plurality of sub-balloons 20Fa are fixed together by fixing component 50.

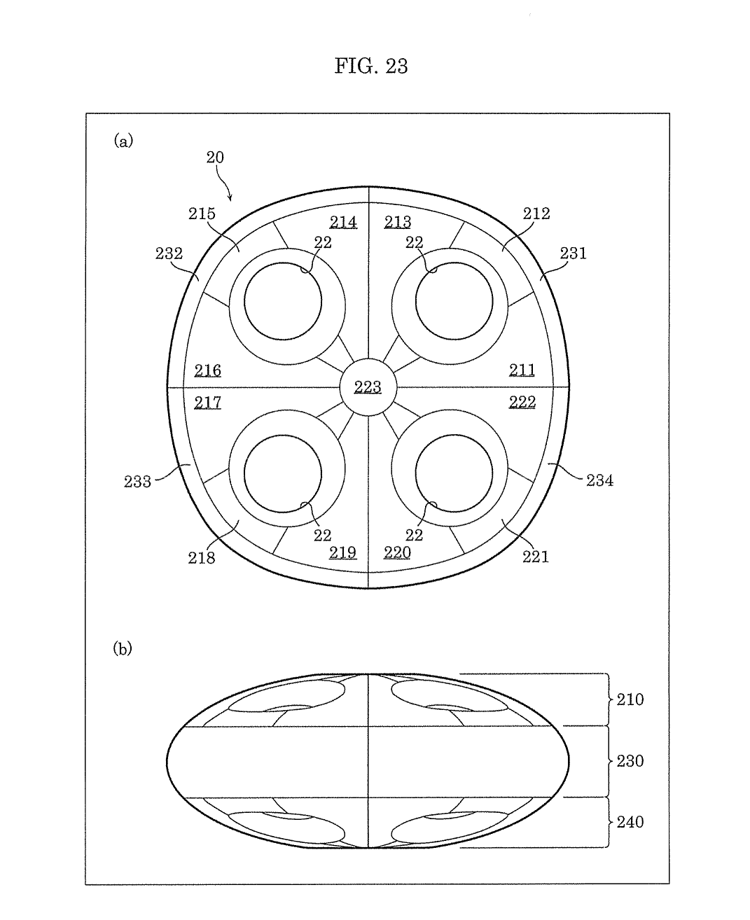

In Embodiments 1 through 6, balloons 20 and 20A through 20D of aircrafts 10 and 10A through 10D may be configured as illustrated in FIG. 23. FIG. 23 illustrates a configuration of a balloon sheet. More specifically, (a) in FIG. 23 is a plan view of balloons 20 and 20A through 20D, and (b) in FIG. 23 is a front view from a side of balloons 20 and 20A through 20D.

As illustrated in (b) in FIG. 23, balloons 20 and 20A through 20D include top sheet 210, bottom sheet 240, and side sheet 230.

Top sheet 210 forms the top of balloons 20 and 20A through 20D. Bottom sheet 240 forms the bottom of balloons 20 and 20A through 20D. As illustrated in (a) in FIG. 23, top sheet 210 includes a plurality of substantially fan-shaped sub-sheets 211 through 222 adhered together at their radial edges to form a sheet whose outer diameter is an approximate circle. Top sheet 210 is an approximately circular sheet including reference curve sections 23 and small curvature radius sections 24 described in Embodiment 1. Moreover, a circular sub-sheet 223 is disposed at the center of top sheet 210, and the tips of the plurality of sub-sheets 211 through 222 are connected to sub-sheet 223. Note that the apex angles of sub-sheets 211 through 222 of top sheet 210 preferably totals less than 360 degrees, as this gives top sheet 210 an approximately conical shape.

Although bottom sheet 240 is not illustrated in detail in the drawings, bottom sheet 240 has the same configuration as top sheet 210, so description thereof is omitted.

Note that top sheet 210 and bottom sheet 240 each include an opening for forming the four ventilation holes 22, and connecting together the openings in top sheet 210 and bottom sheet 240 forms ventilation holes 22.

Side sheet 230 forms the side of balloons 20 and 20A through 20D. Side sheet 230 is configured of rectangular sheet of a plurality of sub-sheets 231 through 234 adhered together at their short ends. Note that the side sheet may be configured of a single rectangular sheet.

One of the two opposing long edges of side sheet 230 is adhered to the peripheral edge of top sheet 210, and the second of the two opposing long edges of side sheet 230 is adhered to the peripheral edge of bottom sheet 240.

In this way, by configuring balloons 20 and 20A though 20D from top sheet 210, bottom sheet 240, and side sheet 230, the side portions of balloons 20 and 20A through 20D include relatively long portions without sections where edges are adhered. Stated differently, by configuring the majority of the side portion of sub-sheets 231 through 234, displays such as advertisements can be printed on the side portion without, for the most part, misalignment or miscoloring arising from adhering the displays. With this, advertisements can be displayed on the side of balloons 20 and 20A through 20D while preserving aesthetics.

In Embodiments 1 through 5, the upper end of connector 25 of aircrafts 10 and 10A through 10C is closed off, but the upper end may be open to the outside. With this, since the space inside connector 25 is open to the outside at both the top and bottom ends, air can more freely flow through the space inside connector 25. For this reason, onboard devices disposed in the space inside connector 25 can be effectively cooled. Note that in this case, when disk 40 includes a plurality of through-holes or cut-aways to further improve air flow, air can flow through the space inside connector 25 even more freely, thereby cooling the onboard devices even more effectively.

In the above Embodiments 1 through 6 and the other embodiments illustrated in FIG. 21 and FIG. 22, aircraft 10 and 10A through 10F include four rotor units 30, but aircraft 10 and 10A through 10F may include two or more rotor units 30; the number of rotor units 30 is not limited to four. However, from the perspective of stabilizing the flight of aircraft 10, aircraft 10 preferably includes three or more rotor units 30.

As described above, balloon 20 of aircraft 10 includes as many ventilation holes 22 as there are rotor units 30. Thus, in aircraft 10 including N (N being an integer greater than 1) rotor units 30, N ventilation holes 22 are defined by balloon 20. In this case, the shape of balloon 20 preferably has rotational symmetry about a vertically extending line (360 degrees/N). Stated differently, in this case, balloon 20 has the same shape after each rotation of (360 degrees/N) about the axis of symmetry. For example, when aircraft 10 includes three rotor units 30, balloon 20 of aircraft 10 preferably has rotational symmetry such that the shape of balloon 20 is the same after each rotation of 120 degrees about the axis of symmetry. Likewise, when aircraft 10 includes six rotor units 30, balloon 20 of aircraft 10 preferably has rotational symmetry such that the shape of balloon 20 is the same after each rotation of 60 degrees about the axis of symmetry.

In the above Embodiments 1 through 6 and the other embodiments illustrated in FIG. 21 and FIG. 22, aircraft 10 and 10A through 10F may be configured such that rotor units 30 are attachable and detachable to and from balloon 20. When rotor units 30 are attachable and detachable to and from balloon 20, rotor units 30 can be detached from balloon 20 and balloon 20 can be folded compactly when transporting aircraft 10. This allows for the transportation packaging for aircraft 10 to be compact.

In the above Embodiments 1 through 6 and the other embodiments illustrated in FIG. 21 and FIG. 22, balloon 20, 20A through 20D, and 20F include the same number of ventilation holes 22 as rotor units 30 (four in Embodiments 1 through 6), and a single rotor unit 30 or 30A is disposed in each ventilation hole 22. However, balloon 20 may include more ventilation holes 22 than rotor units 30. In this case, there will be at least one ventilation hole 22 in which rotor unit 30 is not disposed. When balloon 20 includes ventilation hole 22 in which rotor unit 30 is not disposed, air resistance acting on aircraft 10 during ascent and descent of aircraft 10 can be reduced.

In the above Embodiment 1 through 5, a protective net stretching horizontally across ventilation hole 22 may be provided in each ventilation hole 22 of balloon 20. In this case, in each ventilation hole 22, protective nets may be disposed above and below rotor unit 30. These protective nets are provided in ventilation hole 22 to prevent foreign objects from entering ventilation hole 22 and contacting propeller 32 of rotor unit 30.

Note that in an aircraft including the protective nets, the ventilation holes of the aircraft may be of such a height that the protective net will not contact the rotor unit even if the balloon and the protective net deform as a result of contact from outside. With this, even if an object contacts the protective net, contact between the object and the rotor unit can be reduced.

In the above Embodiments 1 through 6 and the other embodiments illustrated in FIG. 21 and FIG. 22, in aircraft 10 and 10A through 10F, camera 44, projector 43, and luminous body 46 are optional components and may be omitted. These components are irrelevant to the functional capabilities of aircraft 10 itself.

In the above Embodiments 1 through 6 and the other embodiments illustrated in FIG. 21 and FIG. 22, aircraft 10 and 10A through 10F may include a speaker along with, for example, controller 41. When aircraft 10 includes a speaker, sound can be emitted from the speaker and the sheet forming balloon 20 can be vibrated with sound waves to achieve a dramatic effect.

As the above, the non-limiting embodiment has been described by way of example of the technology of the present disclosure. To this extent, the accompanying drawings and detailed description are provided.

Thus, the components set forth in the accompanying drawings and detailed description include not only components essential to solve the problems but also components unnecessary to solve the problems for the purpose of illustrating the above non-limiting embodiments. Thus, those unnecessary components should not be deemed essential due to the mere fact that they are described in the accompanying drawings and the detailed description.

The above non-limiting embodiments illustrate the techniques of the present disclosure, and thus various modifications, permutations, additions and omissions are possible within the scope of the appended claims and the equivalents thereof.

### INDUSTRIAL APPLICABILITY

As described above, the present disclosure is applicable to aircraft including a plurality of rotor units and a balloon.

### REFERENCE MARKS IN THE DRAWINGS

10, 10A to 10E aircraft

20, 20A to 20F balloon

20Fa sub-balloon

21, 21A gas chamber

21a, 21b, 21c, 21d region

22, 22A to 22D, 22E ventilation hole

22a center tubular section

23 reference curve section

24 small curvature radius section

25 connector

26 bulkhead

27 indentation

28 duct

29 window

30, 30A rotor unit

31 frame

32 propeller

33 motor

34, 34a to 34d, 134, 134a to 134d, 334 rudder

35 air conditioning plate

36, 36a to 36d, 136a to 136d actuator

37, 37a to 37d, 137, 137a to 137d, 337 axis of rotation

40 disk

41 controller

41a receiver

41b first controller

41c second controller

42 battery

43 projector

44 camera

45 gimbal

46 luminous body

50 fixing component

51 main body

52 arm

52a distal end

53 voltage regulator

54 support component

55 container

61 tubular component

62, 63 protective net

210 top sheet

211 to 222 sub-sheet

230 side sheet

231 to 234 sub-sheet

240 bottom sheet

1-12. (canceled)

13. An aircraft, comprising:
N rotor units each including a propeller and a motor that drives the propeller, N being an integer greater than or equal to 3;
a shock absorber covering a lateral side of the N rotor units; and
N rudders each being disposed downstream of a corresponding one of the N rotor units and rotating about an axis of rotation that extends in a direction intersecting a flow direction of air current generated by the corresponding one of the N rotor units,
wherein the N rotor units are disposed on a virtual circle at intervals of (360 degrees/N), the virtual circle being centered about a predetermined reference point of the aircraft in a top view.

14. The aircraft according to claim 13,
wherein N is 4.

15. The aircraft according to claim 13,
wherein the shock absorber defines N ventilation holes vertically passing through the shock absorber, and
each of the N rudders is disposed in a different one of the N ventilation holes, together with the corresponding one of the N rotor units.

16. The aircraft according to claim 13,
wherein the shock absorber comprises a balloon containing gas.

17. The aircraft according to claim 13,
wherein each of the N rudders is disposed in an orientation in which the axis of rotation of each of the N rudders intersects the virtual circle along a circumferential direction.

18. The aircraft according to claim 17,
wherein each of the N rudders is disposed in an orientation in which the axis of rotation of each of the N rudders is along a line that connects the predetermined reference point and a center of the corresponding one of the N rotor units.

19. The aircraft according to claim 13,
wherein when the aircraft travels in a horizontal direction, at least one of the N rudders, of which the axis of rotation intersects a direction of travel of the aircraft, tilts to an orientation in which an upstream portion located upstream of air current generated by a corresponding one of the N rotor units is positioned more forward relative to the direction of travel of the aircraft than a downstream portion located downstream of the air current.

20. The aircraft according to claim 13,
wherein when the aircraft rotates, each of the N rudders tilts to an orientation in which an upstream portion located upstream of the air current generated by the corresponding one of the N rotor units is positioned more forward relative to a rotational direction of the aircraft than a downstream portion located downstream of the air current.

21. The aircraft according to claim 20,
wherein when the aircraft rotates, the N rudders tilt toward an identical direction when the N rudders are viewed from the predetermined reference point of the aircraft.

22. The aircraft according to claim 13, further comprising:
a receiver that receives a command signal transmitted from a radio remote control operated by an operator;
a first controller that controls the number of rotations of the N rotor units in accordance with the command signal received by the receiver; and
a second controller that controls tilting of the N rudders in accordance with the command signal received by the receiver.

23. The aircraft according to claim 15,
wherein the N rudders are disposed at bottom end portions of the N ventilation holes.

24. The aircraft according to claim 23,
wherein the bottom ends of the N ventilation holes each have a shape that gradually expands downward in cross sectional area.
